(19) United States
(12) Patent Application Publication
(10) Pub. No.: US 2021/0190605 A1
(43) Pub. Date: Jun. 24, 2021

(54) CORRECTION AMOUNT SETTING APPARATUS, ULTRASONIC OBJECT DETECTING APPARATUS, CORRECTION AMOUNT SETTING METHOD, AND NON-TRANSITORY COMPUTER-READABLE RECORDING MEDIUM HAVING CORRECTION AMOUNT SETTING PROGRAM STORED THEREIN

(71) Applicant: Panasonic Intellectual Property Management Co., Ltd., Osaka (JP)

(72) Inventors: Shingo KAWAHARA, Kanagawa (JP); Yoshimasa OKABE, Kanagawa (JP); Chiaki IZUMOTO, Kanagawa (JP); Sumiaki HAZAMA, Kanagawa (JP); Hiroki YAMASHITA, Kanagawa (JP); Takeo TOMIDA, Kanagawa (JP)

(73) Assignee: Panasonic Intellectual Property Management Co., Ltd., Osaka (JP)

(21) Appl. No.: 17/125,406

(22) Filed: Dec. 17, 2020

(30) Foreign Application Priority Data
Dec. 23, 2019 (JP) 2019-231790
Dec. 23, 2019 (JP) 2019-231794
Dec. 23, 2019 (JP) 2019-231797
Dec. 23, 2019 (JP) 2019-231799
Dec. 23, 2019 (JP) 2019-231802
Sep. 24, 2020 (JP) 2020-159869

(51) Int. Cl. G01K 15/00; G01K 13/04; G01S 15/06; G01S 15/58

(52) U.S. Cl. CPC G01K 15/005; G01S 15/58; G01S 15/06; G01K 13/04

(57) ABSTRACT

A correction amount setting apparatus sets a correction amount for a sound wave sensor that is mounted on a vehicle and that detects an obstacle by transmitting and receiving a sound wave, the correction amount being a correction amount of a sensitivity to a reflection wave or a threshold for determining whether an obstacle is present. The correction amount setting apparatus includes: a correction amount calculator that acquires temperature information from a temperature sensor that detects an outside air temperature around the vehicle and, based on the temperature information, determines the correction amount; and a correction amount setter that determines and sets the correction amount for the sound wave sensor when the vehicle, from start of traveling, after having been accelerated to a speed higher than a reference speed, is decelerated to the reference speed.

### CROSS REFERENCE TO RELATED APPLICATIONS

The entire disclosures of Japanese Patent Application No. 2019-231790 filed on Dec. 23, 2019, Japanese Patent Application No. 2019-231794 filed on Dec. 23, 2019, Japanese Patent Application No. 2019-231797 filed on Dec. 23, 2019, Japanese Patent Application No. 2019-231799 filed on Dec. 23, 2019, Japanese Patent Application No. 2019-231802 filed on Dec. 23, 2019, and Japanese Patent Application No. 2020-159869 filed on Sep. 24, 2020 are incorporated herein by reference in their entirety.

### TECHNICAL FIELD

The present disclosure relates to a correction amount setting apparatus, an ultrasonic object detecting apparatus, a correction amount setting method, and a non-transitory computer-readable recording medium having a correction amount setting program stored therein.

### BACKGROUND ART

A known ultrasonic object detecting apparatus (also referred to as sonar) is mounted on a vehicle and detects an object that is present around the vehicle by transmitting and receiving an ultrasound wave.

Typically, the ultrasonic object detecting apparatus of this type transmits an ultrasound wave and receives a reflection wave that returns from the outside, and compares the intensity of the reflection wave with a threshold for determining whether an object is present (hereinafter, this threshold is referred to as “object determination threshold”), thereby determining whether an object is present.

In the related art, in the ultrasonic object detecting apparatus of this type, considering the temperature dependency of an attenuation amount of a sound wave that propagates in the air, a temperature sensor has calculated an estimated outside air temperature outside the vehicle, and in accordance with the estimated outside air temperature, the object determination threshold or the sensitivity to the reflection wave has been corrected (hereinafter, this processing is also referred to as “temperature compensation processing”) (for example, see PTL 1 and PTL 2).

### CITATION LIST

### Patent Literature

### PTL 1

### Japanese Patent Application Laid-Open No. 2014-089071

### PTL 2

### Japanese Patent Application Laid-Open No. 2016-085040

### SUMMARY OF INVENTION

### Technical Problem

In the ultrasonic object detecting apparatus of this type, if the estimated outside air temperature at the last temperature compensation processing largely deviates from the actual outside air temperature at the current time point, the object determination threshold becomes incorrect, and, as a result, a temporary abnormality (e.g., erroneous detection or detection failure) may occur. Accordingly, while the outside air temperature is changing, there is a demand for performing temperature compensation processing by calculating a more accurate estimated outside air temperature as early as possible.

However, the vehicle may travel in various environments. For example, when a vehicle is heated in a parking lot under a burning sun, when the temperature sensor is iced in a snowstorm, or when a vehicle enters an underground parking lot that is cooled by air-conditioning from a street under a burning sun, the temperature detected by the temperature sensor (hereinafter, this temperature is referred to as “detected temperature”) may be extraordinarily high or extraordinarily low, which largely deviates from the outside air temperature, or detected temperatures indicated by a plurality of temperature sensors in a vehicle may largely differ from each other.

To address such as issue, for example, PTL 1 describes that temperature compensation is performed under the condition that a vehicle has continuously traveled at a speed higher than or equal to a reference speed for a duration that is longer than or equal to a reference duration. According to this method, it is possible to perform temperature compensation processing by using a sensor value of the temperature sensor that is cooled by traveling wind to a temperature close to the outside air temperature. However, the related art according to PTL 1 has an issue of incapability of performing temperature compensation in a case where, for example, the vehicle travels on a jammed road.

In addition, PTL 2 describes that temperature compensation processing is performed by using the lowest detected temperature of detected temperatures detected by a plurality of temperature sensors. However, in a situation where the temperature sensors are iced in a snowstorm, for example, the lowest detected temperature is likely to be a temperature influenced by icing. Thus, by using the related art according to PTL 2, if the vehicle travels in a snowstorm, for example, there is an issue that temperature compensation might not be performed correctly.

The present disclosure has been made in view of the above issues and is directed to providing a correction amount setting apparatus that may perform more appropriate temperature compensation processing, an ultrasonic object detecting apparatus, a correction amount setting method, and a non-transitory computer-readable recording medium having a correction amount setting program stored therein.

### Solution to Problem

The present disclosure mainly solving the problems mentioned above provides a correction amount setting apparatus for setting a correction amount for at least one sound wave sensor that is mounted on a vehicle and that detects an obstacle by transmitting and receiving a sound wave, the correction amount being a correction amount of a sensitivity to a reflection wave or a threshold for determining whether an obstacle is present, the correction amount setting apparatus comprising:

a correction amount calculator that acquires information regarding a detected temperature from a temperature sensor that detects an outside air temperature around the vehicle and determines the correction amount based on the detected temperature; and

a correction amount setter that sets the correction amount for the at least one sound wave sensor,

wherein the correction amount setter sets the correction amount for the at least one sound wave sensor at a first timing, the first timing being a time at which, from start of traveling of the vehicle, the vehicle, after having been accelerated to a speed higher than a first reference speed, is decelerated to the first reference speed.

Further, in another aspect, the present disclosure provides an ultrasonic object detecting apparatus comprising: the correction amount setting apparatus described above.

Further, in another aspect, the present disclosure provides a correction amount setting method for setting a correction amount for a sound wave sensor that is mounted on a vehicle and that detects an obstacle by transmitting and receiving a sound wave, the correction amount being a correction amount of a sensitivity to a reflection wave or a threshold for determining whether an obstacle is present, the correction amount setting method comprising:

first processing in which information regarding a detected temperature is acquired from a temperature sensor that detects an outside air temperature around the vehicle, and the correction amount is determined based on the detected temperature detected by the temperature sensor; and

second processing in which the correction amount is set for the sound wave sensor,

wherein, in the second processing, the correction amount is determined and set for the sound wave sensor at a timing, the timing being a time at which, from start of traveling of the vehicle, the vehicle, after having been accelerated to a speed higher than a first reference speed, is decelerated to the first reference speed.

Further, in another aspect, the present disclosure, a correction amount setting program for setting a correction amount for a sound wave sensor that is mounted on a vehicle and that detects an obstacle by transmitting and receiving a sound wave, the correction amount being a correction amount of a sensitivity to a reflection wave or a threshold for determining whether an obstacle is present, the correction amount setting program comprising:

first processing in which information regarding a detected temperature is acquired from a temperature sensor that detects an outside air temperature around the vehicle and the correction amount is determined based on the detected temperature detected by the temperature sensor; and

second processing in which the correction amount is set for the sound wave sensor,

wherein, in the second processing, the correction amount is determined and set for the sound wave sensor at a timing, the timing being a time at which, from start of traveling of the vehicle, the vehicle, after been accelerated to a speed higher than a first reference speed, is decelerated to the first reference speed.

### Advantageous Effects of Invention

The correction amount setting apparatus according to an embodiment of the present disclosure can perform more appropriate temperature compensation processing.

### BRIEF DESCRIPTION OF DRAWINGS

FIG. 1 illustrates an example of the configuration of an ultrasonic object detecting apparatus according to an embodiment of the present disclosure;

FIG. 2 illustrates an example of a state in which the ultrasonic object detecting apparatus according to an embodiment of the present invention is mounted on a vehicle;

FIG. 3 illustrates examples of an object determination threshold stored in a threshold memory and a reception signal stored in a waveform memory according to an embodiment of the present disclosure;

FIG. 4 is an explanatory diagram of an operation of a sonar ECU according to Embodiment 1;

FIG. 5 is a flowchart illustrating an example of an operation of the sonar ECU according to Embodiment 1;

FIG. 6 is an explanatory diagram of temperature compensation processing performed by the sonar ECU according to Embodiment 2;

FIG. 7 is an explanatory diagram of temperature compensation processing performed by the sonar ECU according to Embodiment 2;

FIG. 8 is a flowchart illustrating an example of an operation of the sonar ECU according to Embodiment 2;

FIG. 9 is an explanatory diagram of the temperature compensation processing performed by the sonar ECU according to Embodiment 4;

FIG. 10 is a flowchart illustrating an example of an operation of the sonar ECU according to Embodiment 4;

FIG. 11 is an explanatory diagram of an operation of the sonar ECU according to Embodiment 5;

FIG. 12 is a flowchart illustrating an operation of the sonar ECU according to Embodiment 5;

FIG. 13 is an explanatory diagram of an operation of the sonar ECU according to Embodiment 6;

FIG. 14 is a flowchart illustrating an operation of the sonar ECU according to Embodiment 6;

FIGS. 15A and 15B illustrate behaviors of detected temperatures from temperature sensors in a plurality of ultrasound wave sensors, respectively, mounted on the vehicle according to Embodiment 7;

FIG. 16 is a flowchart illustrating an operation of the sonar ECU according to Embodiment 7;

FIG. 17 is a flowchart illustrating an operation started by the sonar ECU according to Embodiment 8 when the vehicle is turned on with a key (e.g., when the vehicle is activated); and

FIG. 18 is a flowchart illustrating an operation performed by the sonar ECU according to Embodiment 8 while the vehicle is traveling.

### DESCRIPTION OF EMBODIMENTS

Now, preferred embodiments of the present disclosure will be described in detail with reference to the attached drawings. Note that components having substantially the same functions are denoted by the same reference numerals so as to omit repeated description in the specification and the drawings.

(Basic Configuration of Ultrasonic Object Detecting Apparatus)

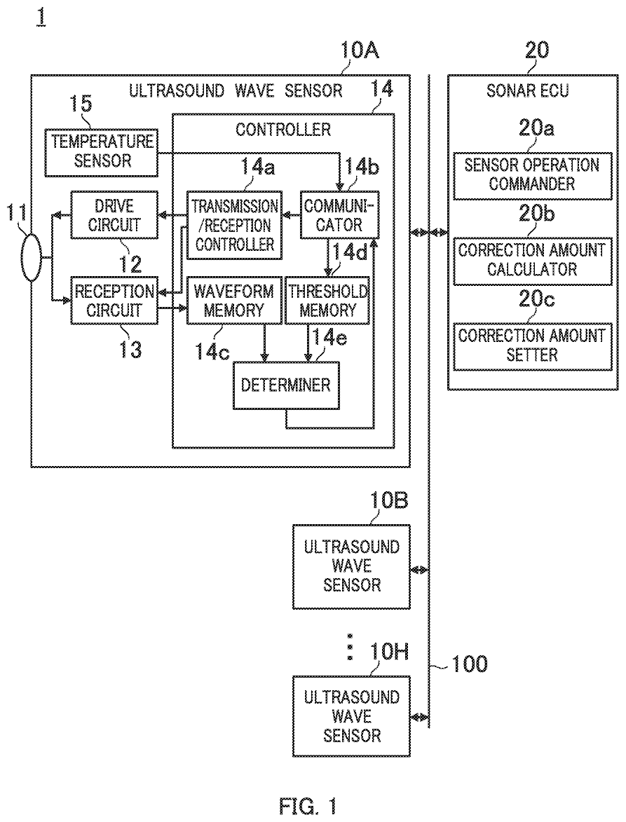

Now, an example of a basic configuration of an ultrasonic object detecting apparatus according to an embodiment of the present disclosure will be described with reference to FIGS. 1 to 3.

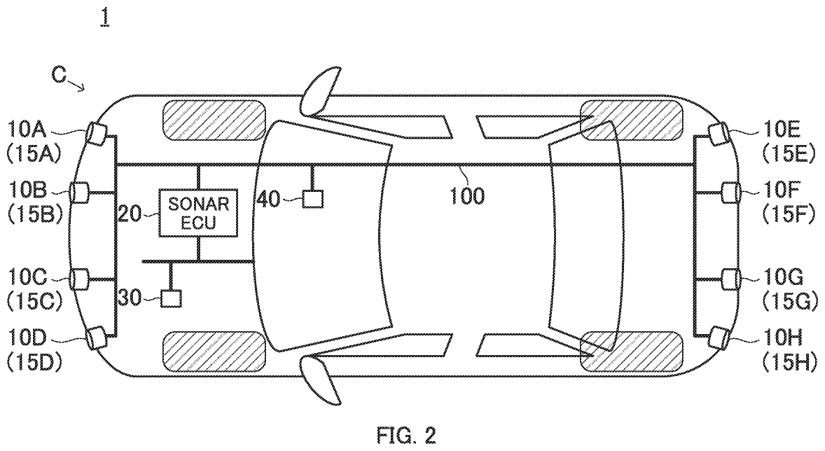

FIG. 1 illustrates an example of the configuration of ultrasonic object detecting apparatus 1 according to an embodiment of the present disclosure. FIG. 2 illustrates an example of a state in which ultrasonic object detecting apparatus 1 according to an embodiment of the present disclosure is mounted on vehicle C.

Ultrasonic object detecting apparatus 1 includes ultrasound wave sensors 10A to 10H (each of which corresponds to “sound wave sensor” in the present invention) and sonar electronic control unit (ECU) 20 (corresponding to “correction amount setting apparatus” in the present invention).

Ultrasonic object detecting apparatus 1 is mounted on vehicle C. Herein, ultrasound wave sensors 10A to 10D are provided in a front part of vehicle C, and ultrasound wave sensors 10E to 10H are provided in a rear part of vehicle C. Ultrasound wave sensors 10A to 10H are typically provided to be exposed to the outside of vehicle C.

Note that ultrasound wave sensors 10A to 10H have substantially the same configuration. Unless ultrasound wave sensors 10A to 10H are distinguished from one another, they are simply referred to as “ultrasound wave sensor 10” or “ultrasound wave sensors 10” in the following description.

Ultrasound wave sensor 10 and sonar ECU 20 can transmit and receive necessary data and control signals to and from each other via on-board network 100 (e.g., a communication network conforming to the CAN communication protocol).

Vehicle C further includes, in addition to ultrasonic object detecting apparatus 1, second temperature sensor 30 and vehicle ECU 40. Second temperature sensor 30 is provided in an air-conditioning apparatus and detects an outside air temperature. Vehicle ECU 40 generally controls a driving state of vehicle C. Sonar ECU 20 can receive information regarding the driving state of vehicle C, and in particular, speed information and traveling direction information via on-board network 100. Sonar ECU 20 is configured to be capable of communicating with second temperature sensor 30 and vehicle ECU 40.

Note that sonar ECU 20 is, for example, a microcomputer including a central processing unit (CPU), a read-only memory (ROM), a random access memory (RAM), a communication interface, and the like. Sonar ECU 20 implements the functions described below by, for example, the CPU referring to control programs and various kinds of data stored in the ROM and the RAM.

[Configuration of Ultrasound Wave Sensor 10]

Ultrasound wave sensor 10 includes transmitter/receiver 11, drive circuit 12, reception circuit 13, controller 14, and temperature sensor 15.

Transmitter/receiver 11 externally transmits an ultrasound wave on the basis of a driving signal from drive circuit 12. Transmitter/receiver 11 receives a reflection wave returning from the outside and outputs a signal indicating an echo intensity of the reflection wave to reception circuit 13. Transmitter/receiver 11 is constituted by, for example, a piezoelectric element that mutually converts an electric signal and an ultrasound wave.

Drive circuit 12 generates a pulsed driving signal and outputs the driving signal to transmitter/receiver 11. Note that the operation of drive circuit 12 is controlled on the basis of a transmission command from controller 14 (transmission/reception controller 14a).

Reception circuit 13 performs amplification processing and A/D conversion processing on the signal indicating the echo intensity of the reflection wave input from transmitter/receiver 11, and outputs the signal subjected to the amplification processing and the A/D conversion processing (hereinafter, this signal is referred to as “reception signal”) to controller 14 (waveform memory 14c).

Controller 14 includes transmission/reception controller 14a, communicator 14b, waveform memory 14c, threshold memory 14d, and determiner 14e. Note that controller 14 is, for example, a microcomputer including a central processing unit (CPU), a read-only memory (ROM), a random access memory (RAM), a communication interface, and the like.

Upon acquisition of an operation instruction signal from sonar ECU 20 through communicator 14b, transmission/reception controller 14a causes drive circuit 12 and reception circuit 13 to operate. Note that transmission/reception controller 14a, for example, issues a command of a timing for generating a driving signal and a pulse width of the driving signal for drive circuit 12. In addition, transmission/reception controller 14a may be capable of adjusting a gain (i.e., the sensitivity to the reflection wave) used by reception circuit 13 to amplify the echo intensity of the reflection wave.

Communicator 14b communicates with sonar ECU 20 via on-board network 100. Communicator 14b receives, from sonar ECU 20, a transmission instruction signal or a correction amount of an object determination threshold, for example. In addition, communicator 14b transmits, to sonar ECU 20, a sensor value of temperature sensor 15 or a result of determination performed by determiner 14e as to whether an object is present, for example.

Waveform memory 14c sequentially stores reception signals received from reception circuit 13. Typically, waveform memory 14c stores time-series data of the signal intensity of the reception signals.

Threshold memory 14d stores an object determination threshold for determining whether an object is present. Note that the object determination threshold is, as described above, a reference value of the signal intensity of the reception signal for determining whether an object is present.

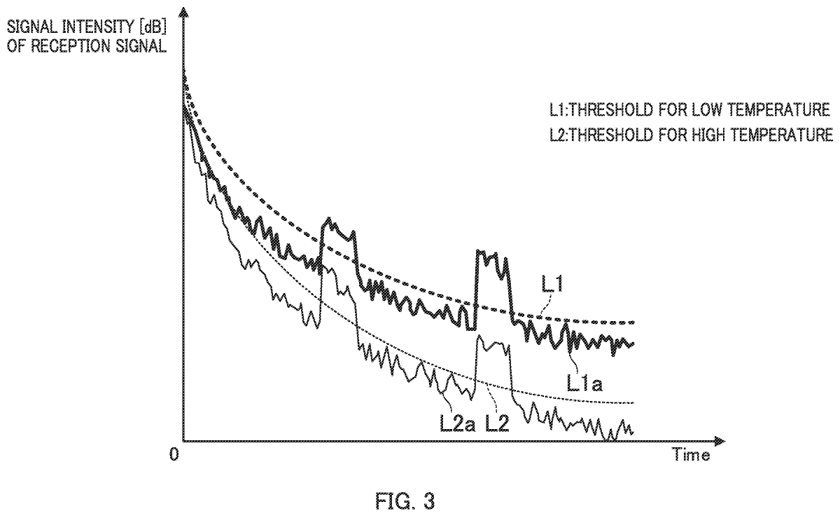

FIG. 3 illustrates examples of the object determination threshold stored in threshold memory 14d and the reception signal stored in waveform memory 14c according to an embodiment of the present disclosure. Note that in FIG. 3, the horizontal axis represents the time from when transmitter/receiver 11 transmits an ultrasound wave until when transmitter/receiver 11 receives a reflection wave thereof, and the vertical axis represents the signal intensity [dB] of the reception signal or the signal intensity [dB] of the object determination threshold.

In FIG. 3, graph L1 represents the object determination threshold for a low outside air temperature (e.g., 10° C.), graph L2 represents the object determination threshold for a high outside air temperature (e.g., 30° C.), graph L1a represents a temporal change in the signal intensity of the reception signal for a low outside air temperature, and graph L2a represents a temporal change in the signal intensity of the reception signal for a high outside air temperature.

The longer the time from when transmitter/receiver 11 transmits an ultrasound wave until when transmitter/receiver 11 receives a reflection wave thereof, the smaller the object determination threshold stored in threshold memory 14d is, for the following reason. The longer the time from when transmitter/receiver 11 transmits an ultrasound wave until when transmitter/receiver 11 receives a reflection wave thereof, the more distant an object is from ultrasound wave sensor 10. The more distant the object is, the larger the attenuation of the ultrasound wave is.

The object determination threshold stored in threshold memory 14d herein is configured to be corrected on the basis of the correction amount specified by sonar ECU 20, considering the temperature dependency of the attenuation amount of the ultrasound wave. Specifically, through this correction processing, the object determination threshold stored in threshold memory 14d is set to a relatively small value if the outside air temperature is high or is set to a relatively large value if the outside air temperature is low.

Note that, for example, a reference value of the object determination threshold for an average outside air temperature (e.g., 20° C.) is stored in controller 14, and the correction amount of the object determination threshold transmitted from sonar ECU 20 is added to or subtracted from the reference value of the object determination threshold, and the resultant value is set in threshold memory 14d. Note that the memory structure of threshold memory 14d for enabling temperature compensation may be any structure, and, for example, the object determination threshold for each temperature may be stored in advance in the storage (e.g., the ROM) of controller 14. Alternatively, the correction amount of the object determination threshold may be added to or subtracted from the reference value of the object determination threshold by sonar ECU 20, and then the object determination threshold subjected to addition/subtraction of the correction amount may be transmitted from sonar ECU 20 and stored in the storage (e.g., the RAM) of controller 14, for the following reason. To transmit the correction amount for addition/subtraction of the correction amount is the same as to transmit the threshold subjected to addition/subtraction for storage, in setting the correction amount for the sound wave sensor.

Determiner 14e compares the signal intensity of the reception signal stored in waveform memory 14c with the object determination threshold stored in threshold memory 14d. If the signal intensity of the reception signal is greater than or equal to the object determination threshold, determiner 14e determines that an object is present; if the signal intensity of the reception signal is less than the object determination threshold, determiner 14e determines that no object is present. In addition, if an object is detected, determiner 14e transmits information regarding the object to sonar ECU 20.

At this time, if determiner 14e determines that an object is present, on the basis of a reception timing (a time difference from when transmitter/receiver 11 transmits an ultrasound wave until when transmitter/receiver 11 receives a reflection wave that is greater than or equal to the object determination threshold), determiner 14e may calculate the distance from vehicle C to the object. Note that the distance from ultrasound wave sensor 10 to the object is ½ of a value obtained by multiplying, by the speed of sound, the time difference from when transmitter/receiver 11 transmits an ultrasound wave until when transmitter/receiver 11 receives a reflection wave that is greater than or equal to the object determination threshold).

Temperature sensor 15 is a temperature detector built in ultrasound wave sensor 10 and detects an atmosphere temperature around vehicle C, and more specifically, an atmosphere temperature around transmitter/receiver 11. Temperature sensor 15 is provided for the purpose of detecting the outside air temperature and detects the outside air temperature in a normal state. However, being built in ultrasound wave sensor 10, temperature sensor 15 may be influenced by the temperature inside ultrasound wave sensor 10 or the temperature of a bumper that is in contact with ultrasound wave sensor 10. In addition, if a water drop or snow is attached to ultrasound wave sensor 10, temperature sensor 15 may be influenced by the temperature of the attached matter. For example, temperature sensor 15 may be a thermistor. Temperature information detected by temperature sensor 15 is transmitted to sonar ECU 20 through controller 14 (communicator 14b). Note that temperature sensor 15 may also be referred to as any of temperature sensors 15A to 15H in the following description if temperature sensors 15 in plural ultrasound wave sensors 10A to 10H, respectively, are distinguished from one another.

[Configuration of Sonar ECU 20]

Sonar ECU 20 includes sensor operation commander 20a, correction amount calculator 20b, and correction amount setter 20c.

Sensor operation commander 20a transmits an operation command signal to ultrasound wave sensor 10. Upon acquiring the operation command signal from sensor operation commander 20a, ultrasound wave sensor 10 starts an operation of transmitting an ultrasound wave and receiving a reflection wave thereof.

On the basis of the speed of vehicle C, sensor operation commander 20a herein determines whether ultrasound wave sensor 10 is to operate. Specifically, only if the speed of vehicle C is less than or equal to a predetermined speed (corresponding to a second reference speed described later), sensor operation commander 20a causes ultrasound wave sensor 10 to operate, for the following reason. Since the distance for which an obstacle can be detected by using an ultrasound wave is short, if an obstacle is detected by using an ultrasound wave while vehicle C is traveling at a high speed, emergency braking may be too late. In addition, sensor operation commander 20a is configured not to cause ultrasound wave sensor 10 to operate from the time point at which vehicle C is turned on with a key until when temperature compensation processing is performed. Note that the “predetermined speed” is, for example, 12 to 18 km/h.

Correction amount calculator 20b acquires, from temperature sensors 15 of all ultrasound wave sensors 10, temperature information (i.e., detected temperatures) regarding the outside air temperature around vehicle C (i.e., around ultrasound wave sensors 10). Correction amount calculator 20b, for example, successively acquires the detected temperatures from all temperature sensors 15 while vehicle C is traveling.

Note that correction amount calculator 20b may also acquire a detected temperature from second temperature sensor 30 that is provided in vehicle C and that detects the outside air temperature.

As a value to be used as the outside air temperature when calculating the correction amount (hereinafter, this value is referred to as “reference temperature”), correction amount calculator 20b may select one of the plurality of detected temperatures and use the temperature as the reference temperature, or may use the average of the plurality of detected temperatures as the reference temperature to calculate the correction amount of the object determination threshold.

Note that the storage (e.g., the RAM) of sonar ECU 20 successively stores information regarding the detected temperature detected by temperature sensor 15 acquired by correction amount calculator 20b, and on the basis of a transition of the detected temperature stored in the storage, correction amount calculator 20b may calculate an estimated outside air temperature and may use the estimated outside air temperature as the reference temperature to calculate the correction amount of the object determination threshold. Alternatively, correction amount setter 20c may typically use the detected temperature from temperature sensor 15 at the current time point as the reference temperature to calculate the correction amount of the object determination threshold for ultrasound wave sensor 10.

Correction amount calculator 20b may alternatively perform the above operation for calculating the correction amount by, for example, reading the correction amount of the object determination threshold in accordance with the reference temperature (the estimated outside air temperature or the detected temperature at the current time point) from a correction data table that is stored in advance in the storage (e.g., the ROM) of sonar ECU 20. The correction data table stores, for example, for each reference temperature, the correction amount of the object determination threshold in accordance with the time from when transmitter/receiver 11 transmits an ultrasound wave until when transmitter/receiver 11 receives a reflection wave (see FIG. 3). Note that the correction data table stores, for example, a correction amount from the object determination threshold for the average outside air temperature (e.g., 20° C.). The more the reference temperature deviates from the average outside air temperature, the larger the stored correction amount is.

Correction amount setter 20c performs correction amount setting processing in which the correction amount of the object determination threshold calculated by correction amount calculator 20b is transmitted to ultrasound wave sensor 10 so as to perform the temperature compensation processing in the end. In addition, if sonar ECU 20 is configured to add or subtract the correction amount of the object determination threshold to or from the reference value of the object determination threshold, sonar ECU 20 transmits, to controller 14, the object determination threshold subjected addition/subtraction of the correction amount so as to perform the correction amount setting processing in the end. Note that the target to be corrected by correction amount setter 20c may be, instead of the object determination threshold to be set in threshold memory 14d, the sensitivity to the reflection wave (i.e., a gain) of reception circuit 13.

Sonar ECU 20 according to an embodiment of the present disclosure has features in the timing at which correction amount setter 20c performs the temperature compensation processing and in the use of the reference temperature used when correction amount calculator 20b calculates the correction amount. Now, various embodiments of the temperature compensation processing employed by sonar ECU 20 according to an embodiment of the present disclosure will be described.

### Embodiment 1

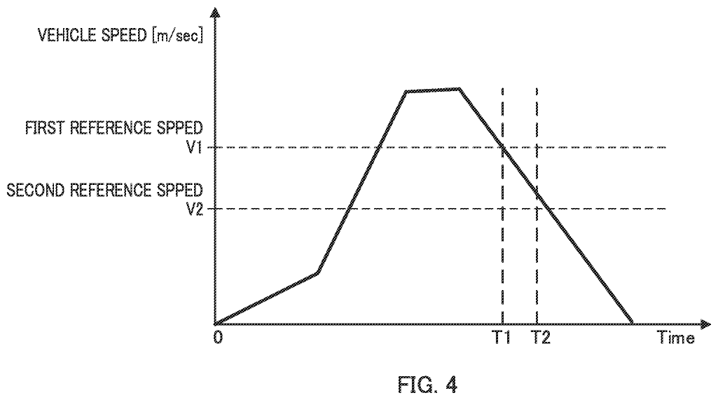

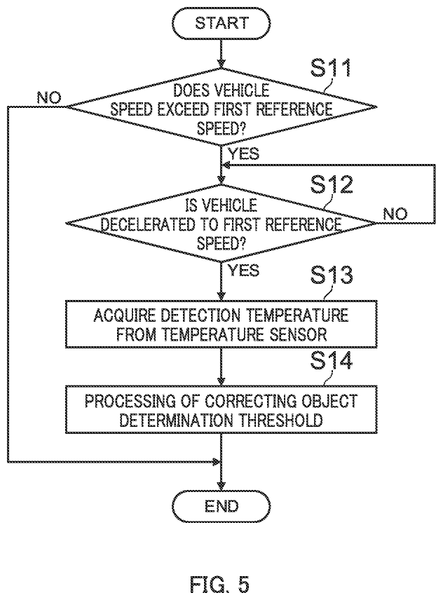

Now, the configuration of sonar ECU 20 according to Embodiment 1 will be described below with reference to FIGS. 4 and 5.

Sonar ECU 20 (correction amount setter 20c) according to this embodiment has a feature in transmitting the correction amount of the object determination threshold at a timing at which, from the start of traveling of vehicle C (including a case of start from a parking state), vehicle C, after having been accelerated to a speed higher than a first reference speed, is decelerated to the first reference speed.

FIG. 4 is an explanatory diagram of an operation of sonar ECU 20 according to this embodiment. Note that FIG. 4 illustrates a change in the speed of vehicle C. In FIG. 4, the horizontal axis represents the time, and the vertical axis represents the speed [m/sec] of vehicle C. Note that T1 represents a start timing of the temperature compensation processing, and T2 represents an end timing of the temperature compensation processing in FIG. 4.

As described above, for example, if vehicle C is heated in a parking lot under a burning sun, the detected temperature indicated by temperature sensor 15 becomes extraordinarily high, and the object determination threshold becomes incorrect. As a result, a temporary abnormality (erroneous detection or detection failure) may occur. In addition, such a situation may also occur when vehicle C is parked for a long time in a traffic jam under a burning sun.

Even if vehicle C is heated under a burning sun, for example, sonar ECU 20 according to this embodiment performs the temperature compensation processing for the object determination threshold so that the object determination threshold can be corrected to an appropriate value as early as possible and at an appropriate timing. That is, sonar ECU 20 starts to monitor the speed of vehicle C when vehicle C starts to travel and performs the temperature compensation processing at a timing at which vehicle C is decelerated to the first reference speed from a state of traveling at a speed higher than the first reference speed (V1 in FIG. 4). Note that sonar ECU 20 according to this embodiment successively acquires the speed of vehicle C at the current time point from vehicle ECU 40.

The “first reference speed” (V1 in FIG. 4) herein to be used as the reference of the timing for performing the temperature compensation processing for the object determination threshold is a speed higher than or equal to a predetermined speed to be used as a reference for causing ultrasound wave sensor 10 to operate (hereinafter, this predetermined speed is also referred to as “second reference speed”) (V2 in FIG. 4). As the “first reference speed”, preferably, a speed higher than the second reference speed by 3 to 10 km/h, and for example, 20 to 25 km/h is set.

If vehicle C travels at a speed higher than or equal to the first reference speed, temperature sensor 15 is sufficiently cooled by traveling wind, and the detected temperature indicated by temperature sensor 15 is assumed to have converged to the actual outside air temperature. The timing at which vehicle C is decelerated to the first reference speed corresponds to the timing at which or immediately before ultrasound wave sensor 10 starts to operate.

That is, since the temperature compensation processing is performed at a timing at which vehicle C is decelerated to the first reference speed after having been accelerated to a speed higher than the first reference speed, the object determination threshold can be corrected to an appropriate value as early as possible and immediately before ultrasound wave sensor 10 needs to start to operate.

In addition, this can reduce the frequency for performing the temperature compensation processing. For example, this can limit the frequency for performing the temperature compensation processing to only the first time at which vehicle C is decelerated to the first reference speed after having been accelerated to a speed higher than the first reference speed from the start of traveling of vehicle C by being turned on with a key. Thus, unlike in PTL 1, the temperature compensation processing can be prevented from being unnecessarily repeated while vehicle C is traveling at a high speed. This can prevent unnecessary power from being consumed, unnecessary electromagnetic wave from being radiated, unnecessary channel capacity from being generated, a threshold memory from being degraded in accordance with high-frequency data overwriting, or the like.

In addition, if the first reference speed is set to a speed higher than the second reference speed by 3 to 10 km/h, the temperature compensation processing can be completed immediately before ultrasound wave sensor 10 starts to operate. That is, this can prevent a delay in detecting an object by ultrasound wave sensor 10, which is caused by an interruption time of object detection for the temperature compensation processing. Typically, the deceleration rate of vehicle C has a practical upper limit (emergency braking: according to the international standard for autonomous emergency braking system (AEBS), the deceleration rate is 4 m/s² or higher, and in a typical design, the deceleration rate is 0.5G=about 4.9 m/s² even at full braking by emergency braking being activated under a good road condition. It is allowed to decrease the deceleration rate under a bad road condition.). Thus, for example, if the first reference speed is 25 km/h and the second reference speed is 20 km/h, at least 300 msec can be spared while vehicle C is decelerated by 5 km/h. A duration of about 300 msec may be sufficient to determine the correction amount of the object determination threshold and to end transmission of data regarding the correction amount.

Note that sonar ECU 20 according to this embodiment may perform the temperature compensation processing only once, which is the first time at which vehicle C is decelerated to the first reference speed. However, since the outside air temperature around vehicle C is monitored on a regular basis, the temperature compensation processing may be performed every time vehicle C is decelerated to the first reference speed after having been accelerated to a speed higher than the first reference speed.

In addition, to prevent the temperature compensation processing from being performed in a state where temperature sensor 15 is not cooled sufficiently, sonar ECU 20 preferably sets a condition on the traveling duration during which vehicle C travels at a speed higher than the first reference speed. In this case, the configuration may be such that, at a timing at which vehicle C is decelerated to the first reference speed after having been accelerated to a speed higher than the first reference speed, for example, sonar ECU 20 determines whether the traveling duration during which vehicle C travels at a speed higher than the first reference speed is longer than or equal to a reference duration. If the traveling duration is longer than or equal to the reference duration, the temperature compensation processing is performed; if the traveling duration is shorter than the reference duration, the temperature compensation processing is not performed. Note that in this case, it is preferable to employ a setting method according to Embodiment 3 as a method for setting the time range of the reference duration.

FIG. 5 is a flowchart illustrating an example of an operation of sonar ECU 20 according to this embodiment.

In step S11, sonar ECU 20 determines whether the speed of vehicle C exceeds the first reference speed. If the speed of vehicle C exceeds the first reference speed (S11: YES), sonar ECU 20 advances the process to step S12; if the speed of vehicle C does not exceed the first reference speed (S11: NO), sonar ECU 20 ends the process in the flowchart illustrated in FIG. 5.

In step S12, sonar ECU 20 determines whether vehicle C is decelerated to the first reference speed, and waits for vehicle C to be decelerated to the first reference speed (S12: NO). When vehicle C is decelerated to the first reference speed (S12: YES), sonar ECU 20 advances the process to step S13.

In step S13, sonar ECU 20 acquires information regarding the detected temperature from temperature sensor 15.

In step S14, on the basis of the information regarding the detected temperature at the current time point acquired in step S13, sonar ECU 20 determines the correction amount of the object determination threshold and transmits data regarding the correction amount to ultrasound wave sensor 10. At this time, if ultrasound wave sensor 10 stores the reference value of the object determination threshold, sonar ECU 20 may transmit the correction amount of the object determination threshold to ultrasound wave sensor 10 as the data regarding the correction amount; if ultrasound wave sensor 10 does not have the reference value of the object determination threshold, sonar ECU 20 may add or subtract the correction amount of the object determination threshold to the reference value of the object determination threshold and transmit the object determination threshold subjected to addition/subtraction of the correction amount to ultrasound wave sensor 10 as the data regarding the correction amount. Regardless of whether the data regarding the correction amount is the correction amount itself or data subjected to the addition/subtraction of the correction amount, the timing at which the data regarding the correction amount is transmitted to ultrasound wave sensor 10 is the timing at which the correction amount for ultrasound wave sensor 10 is set.

Sonar ECU 20 according to this embodiment, for example, repeatedly performs the operation in this flowchart at predetermined time intervals (e.g., intervals of 100 ms) while vehicle C is traveling.

Through the above process, the temperature compensation processing can be performed at an appropriate timing without unnecessarily repeating the temperature compensation processing. The above description mainly illustrates the timing at which sonar ECU 20 sets the correction amount of the object determination threshold. However, the timing at which sonar ECU 20 calculates the correction amount is not necessarily the same timing with the timing at which sonar ECU 20 sets the correction amount. In the flowchart illustrated in FIG. 5, the information regarding the detected temperature is acquired after vehicle C has been decelerated to the first reference speed. However, the correction amount calculation processing can be performed independently of the correction amount setting processing. Thus, for example, sonar ECU 20 may repeat calculation of the correction amount of the object determination threshold at predetermined time intervals (e.g., intervals of 1 s), and sonar ECU 20 may set the most recent correction amount at the timing of step S14 for ultrasound wave sensor 10, for the following reason. Since the transition of the detected temperature is typically gradual, even if the time point for acquiring the detected temperature and calculating the correction amount changes from the time point immediately before the correction amount setting to the time point 1 second before the correction amount setting, the result of correction is not largely different. The time from when vehicle C is decelerated to the first reference speed until when ultrasound wave sensor 10 starts to operate is short, and thus, by separately performing the correction amount calculation processing in advance, a more inexpensive processing apparatus can implement the function.

[Effects]

As described above, at a timing at which vehicle C is decelerated to the first reference speed (e.g., 20 to 25 km/h) after having been accelerated to a speed higher than the first reference speed from the start of traveling of vehicle C, sonar ECU 20 according to this embodiment determines the correction amount of the object determination threshold and sets the correction amount for ultrasound wave sensor 10.

Thus, according to sonar ECU 20 according to this embodiment, the object determination threshold can be corrected to an appropriate value as early as possible and at an appropriate timing. In particular, sonar ECU 20 according to this embodiment is useful in that the timing for performing the temperature compensation processing for the object determination threshold can be limited to the timing immediately before ultrasound wave sensor 10 starts to operate and in that the frequency for performing the temperature compensation processing can be reduced.

Thus, unlike PTL 1, the temperature compensation processing can be prevented from being unnecessarily repeated while vehicle C is traveling at a high speed. This can prevent unnecessary power from being consumed, unnecessary electromagnetic wave from being radiated, unnecessary channel capacity from being generated, a threshold memory from being degraded in accordance with high-frequency data overwriting, or the like.

### Embodiment 2

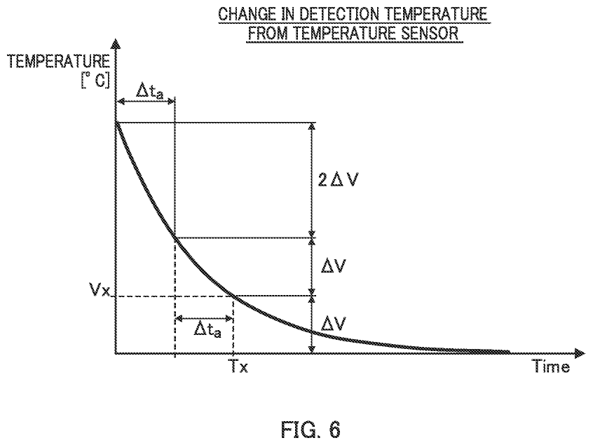

Now, the configuration of sonar ECU 20 according to Embodiment 2 will be described below with reference to FIGS. 6 to 8. Sonar ECU 20 (correction amount calculator 20b) according to this embodiment has a feature in using, as the reference temperature to be referred to when performing temperature compensation, an estimated value estimated from a transition of the detected temperature from temperature sensor 15.

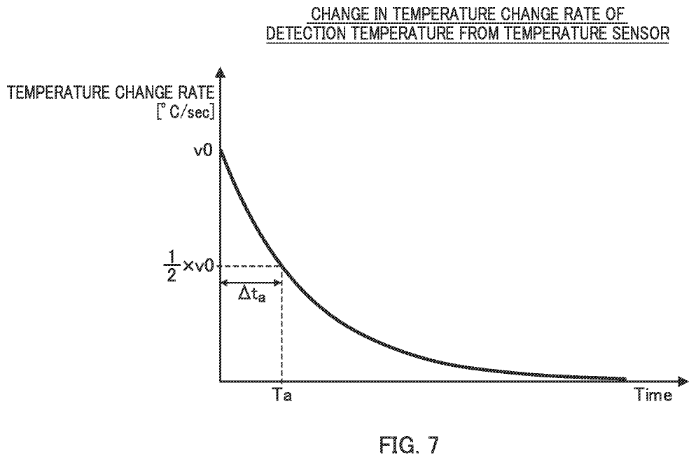

FIGS. 6 and 7 are explanatory diagrams of the temperature compensation processing performed by sonar ECU 20 according to Embodiment 2.

FIG. 6 illustrates an example of a transition of the detected temperature from temperature sensor 15 when temperature sensor 15 in a high-temperature state is gradually cooled by traveling wind against vehicle C. In FIG. 6, the horizontal axis represents an elapsed time after the start of cooling of temperature sensor 15, and the vertical axis represents the detected temperature based on the actual outside air temperature (hereinafter referred to as “actual temperature”).

As described above, in a case where vehicle C is heated in a parking lot under a burning sun, temperature sensor 15 is incapable of detecting an accurate outside air temperature at the start of traveling of vehicle C. Thus, the timing for determining the correction amount of the object determination threshold is preferably after temperature sensor 15 has been cooled by traveling wind and become to function normally. However, if temperature compensation is performed after waiting for the time at which the detected temperature from temperature sensor 15 is expected to have converged sufficiently, the time point for starting temperature compensation is late. In addition, in a case of simply using the detected temperature from temperature sensor 15 obtained when the reference duration that is specified in advance has elapsed, a temperature difference may remain between the detected temperature and the actual temperature.

From the above viewpoint, sonar ECU 20 (correction amount calculator 20b) according to this embodiment estimates the actual outside air temperature on the basis of a temporal transition of the detected temperature from temperature sensor 15 and determines the correction amount of the object determination threshold on the basis of the estimated outside air temperature. This enables earlier and more accurate temperature compensation.

The amount of heat to move by air cooling is generally in proportion to the difference between the detected temperature from temperature sensor 15 and the actual temperature, and thus, the temperature difference generally decreases in accordance with an exponential function. Herein, in a case where the detected temperature from temperature sensor 15 converges toward the actual temperature in accordance with the exponential function, as illustrated in FIG. 6, when the detected temperature at a certain time point Tx is Vx, Δtₐ is present that satisfies the detected temperature at a timing Tx−Δtₐ is Vx+ΔV and the detected temperature at a timing Tx−2Δtₐ is Vx+3ΔV. This Δtₐ is a half-life of the temperature difference between the detected temperature from temperature sensor 15 and the actual temperature. In this case, the detected temperature from temperature sensor 15 converges toward Vx−ΔV, and the value Vx−ΔV can be estimated to be the actual temperature. The convergent value Vx−ΔV of the temperature change is referred to as convergent temperature. Starting from the timing Tx−2Δtₐ, when the first Δtₐ passes, the temperature difference between the detected temperature from temperature sensor 15 and the actual temperature is reduced by half, which is from 4ΔV to 2ΔV, and when another Δtₐ passes, the temperature difference between the detected temperature from temperature sensor 15 and the actual temperature is reduced by half, which is from 2ΔV to ΔV. Thus, in other words, the timing Tx is a time point at which twice the half-life has passed.

Thus, from the start of temperature detection by temperature sensor 15, sonar ECU 20 according to this embodiment monitors a transition of the detected temperature from temperature sensor 15 and detects the timing Tx corresponding to the time point at which twice the half-life has passed. In addition, sonar ECU 20 estimates, as the actual outside air temperature (i.e., the actual temperature), Vx−ΔV obtained by subtracting ΔV from the detected temperature Vx at the timing Tx corresponding to the time point at which twice the half-life has passed, and performs temperature compensation for the object determination threshold by using the estimated outside air temperature.

At this time, sonar ECU 20 may monitor a change in a temperature change rate (i.e., the temperature change amount per unit time) of the detected temperature from temperature sensor 15, and, on the basis of the change in the temperature change rate, may determine the timing Tx corresponding to the time point at which twice the half-life has passed.

FIG. 7 illustrates an example of the change in the temperature change rate of the detected temperature from temperature sensor 15 when temperature sensor 15 in a high-temperature state is gradually cooled by traveling wind against vehicle C. In FIG. 7, the horizontal axis represents an elapsed time after the start of cooling of temperature sensor 15, and the vertical axis represents the temperature change rate of the detected temperature from temperature sensor 15. Note that Ta in FIG. 7 represents the timing corresponding to the time point at which twice the half-life has passed.

Since the change in the temperature difference is an exponential function, the temperature change rate, which is the differential thereof, is also an exponential function. When the temperature change rate is referred to as a temperature change per unit time, the half-life is also referred to as “the time until the temperature change rate changes from an initial value (v0 in FIG. 7) to a half value (v0×½ in FIG. 7)” (=Δtₐ in FIG. 7). That is, from the change in the temperature change rate indicated by the detected temperature from temperature sensor 15, correction amount calculator 20b according to this embodiment can find the timing Ta at which the temperature change rate becomes from the initial value to ½, thereby determining the half-life. If the detected temperature from temperature sensor 15 at the timing Ta is Vx, and the temperature at the time point Ta−Δtₐ, which is earlier than the timing Ta by the half-life Ata, is Vx+ΔV, it may be assumed that the detected temperature from temperature sensor 15 converges toward the convergent temperature=Vx−ΔV.

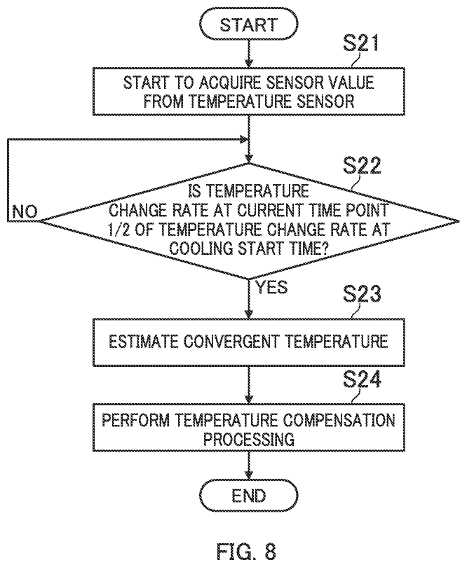

FIG. 8 is a flowchart illustrating an example of an operation of sonar ECU 20 according to this embodiment. Note that the process in this flowchart is started when, for example, vehicle C is turned on with a key.

In step S21, sonar ECU 20 starts to acquire a sensor value (i.e., the detected temperature) from temperature sensor 15. In addition, from the time point at the start of acquisition of the sensor value of temperature sensor 15, sonar ECU 20 successively calculates a change rate (i.e., the temperature change rate per unit time) of the sensor value at each time point.

In step S22, on the basis of the sensor value of temperature sensor 15, sonar ECU 20 waits for the temperature change rate of the detected temperature at the current time point to be reduced to ½ of the temperature change rate of the detected temperature at the cooling start time (i.e., a reference of the temperature change rate for determining whether the temperature change rate is reduced by half) (S22: NO). When the temperature change rate of the detected temperature at the current time point is reduced to ½ of a reference of the temperature change rate of the detected temperature at the cooling start time (S22: YES), sonar ECU 20 advances the process to step S23. Note that, at this time, for example, sonar ECU 20 may assume that the time point at which vehicle C starts to travel or the time point at which vehicle C is accelerated to the first reference speed is the cooling start time, and may use the temperature change rate of the detected temperature at this time point as the reference of the temperature change rate of the detected temperature at the cooling start time, or may assume that the time point at which the temperature change rate of the detected temperature peaks is the cooling start time, and, using the temperature change rate of the detected temperature at this point as the reference, may wait for the temperature change rate of the measured detected temperature to be reduced to ½ of the reference.

In step S23, sonar ECU 20 determines that the time taken for the temperature change rate of the detected temperature at the current time point to be reduced to ½ of the temperature change rate of the detected temperature at the cooling start time is the half-life until the detected temperature from temperature sensor 15 converges to the actual temperature, and estimates the actual temperature (i.e., the convergent temperature estimated from the half-life) by substantially the same method as that described with reference to FIG. 6.

In step S24, on the basis of the actual temperature estimated in step S23, sonar ECU 20 performs the temperature compensation processing for the object determination threshold. That is, at this time, on the basis of the actual temperature estimated in step S23, sonar ECU 20 determines the correction amount of the object determination threshold and sets the correction amount for ultrasound wave sensor 10.

Note that the flowchart in FIG. 8 illustrates a case in which sonar ECU 20 calculates the estimated value estimated from the detected temperature from temperature sensor 15 (i.e., the convergent temperature estimated from the half-life) only once. However, sonar ECU 20 preferably updates the estimated value at predetermined time intervals (e.g., intervals of 1 s). In this case, from the change in the temperature change rate of the detected temperature from temperature sensor 15, sonar ECU 20 may find a timing at which the temperature change rate is twice the temperature change rate at this time point to repeat determination of the half-life and estimation of the actual temperature. The most recent measured value is closer to the actual temperature than the previous measured value is, and thus, by repeating such estimation, it is possible to estimate the actual temperature more accurately from the detected temperature from temperature sensor 15. In addition, by repeating such estimation, even if the vehicle speed or the outside air temperature changes, it is possible to estimate the actual temperature accurately from the detected temperature from temperature sensor 15.

In addition, to match with the timing for performing the temperature compensation processing described in Embodiment 1, sonar ECU 20 may perform the correction amount setting processing at a timing at which vehicle C is decelerated to the first reference speed after having been accelerated to a speed higher than the first reference speed. In this case, sonar ECU 20 may determine the correction amount of the object determination threshold on the basis of the outside air temperature estimated at the time point at which the correction amount setting processing is performed or may use the most recent correction amount obtained by repeated calculation at predetermined time intervals. Furthermore, if sonar ECU 20 performs the processing for adding/subtracting the correction amount of the object determination threshold to set the resultant value as the object determination threshold, sonar ECU 20 may perform addition/subtraction at the time of calculating the correction amount or may perform addition/subtraction immediately before transmitting the threshold to ultrasound wave sensor 10. In any case, the timing at which data regarding the correction amount (the correction amount or the threshold subjected to addition/subtraction of the correction amount) is transmitted to ultrasound wave sensor 10, not the timing at which addition/subtraction is performed, is the timing at which the correction amount setting processing for setting the correction amount for the sound wave sensor is performed.

[Effects]

As described above, on the basis of the change in the outside air temperature detected by temperature sensor 15, sonar ECU 20 according to this embodiment estimates the actual outside air temperature, and determines the correction amount of the object determination threshold on the basis of the estimated outside air temperature.

This enables earlier and more accurate temperature compensation for the object determination threshold.

### Embodiment 3

Now, the configuration of sonar ECU 20 according to Embodiment 3 will be described below. Sonar ECU 20 (correction amount calculator 20b and correction amount setter 20c) according to this embodiment has a feature in determining the timing for performing the temperature compensation processing on the basis of the transition of the detected temperature detected by temperature sensor 15.

For example, on the basis of the transition of the detected temperature from temperature sensor 15, sonar ECU 20 according to this embodiment determines the timing at which the detected temperature from temperature sensor 15 converges to a temperature around the actual temperature, and performs the temperature compensation processing by using the detected temperature from temperature sensor 15 at the timing. In other words, when vehicle C starts to travel, sonar ECU 20 according to this embodiment sets a waiting time until performing the temperature compensation processing.

The method by which sonar ECU 20 according to this embodiment determines the timing at which the detected temperature from temperature sensor 15 converges to a temperature around the actual temperature is substantially the same as the method described in Embodiment 2. That is, on the basis of the transition of the detected temperature from temperature sensor 15 or the change in the temperature change rate of the detected temperature from temperature sensor 15, sonar ECU 20 determines the half-life from the time point at which cooling of temperature sensor 15 is started (e.g., the time point at which vehicle C starts to travel at a speed higher than or equal to the first reference speed) until the detected temperature from temperature sensor 15 converges to the actual temperature. In addition, from the half-life, sonar ECU 20 determines the timing at which the detected temperature from temperature sensor 15 converges to a temperature around the actual temperature.

After the half-life has passed, the temperature compensation processing may be performed at any timing. For example, the temperature compensation processing may be performed at an end timing of 80% temperature change of the temperature change in a duration until the detected temperature from temperature sensor 15 at a time point at which vehicle C is turned on with a key converges to the actual temperature or a timing at which the difference between the detected temperature from temperature sensor 15 and the actual temperature falls within a predetermined allowable range, such as 5 degrees.

Subsequently, sonar ECU 20 according to this embodiment waits for the time to pass until the determined timing for performing the temperature compensation processing, and then acquires information regarding the detected temperature from temperature sensor 15. At the timing, sonar ECU 20 performs the temperature compensation processing by using the detected temperature detected by temperature sensor 15.

[Effect]

As described above, on the basis of the transition of the detected temperature from temperature sensor 15, sonar ECU 20 according to this embodiment estimates the timing at which the detected temperature converges to a temperature around the actual temperature and determines the timing for performing the temperature compensation processing.

This enables earlier and more accurate temperature compensation for the object determination threshold.

Note that the method by which sonar ECU 20 according to this embodiment sets the waiting time may be applied as, for example, a method by which sonar ECU 20 according to Embodiment 1 sets a time range of the reference duration of the traveling duration (i.e., the traveling duration during which vehicle C travels at a speed higher than the first reference speed). In this case, after vehicle C has started to travel, when the speed of vehicle C exceeds the first reference speed, on the basis of the transition of the detected temperature detected by temperature sensor 15, sonar ECU 20 may set the time range of the reference duration. This can make sure to prevent the temperature compensation processing from being performed in a state where temperature sensor 15 is not sufficiently cooled.

### Embodiment 4

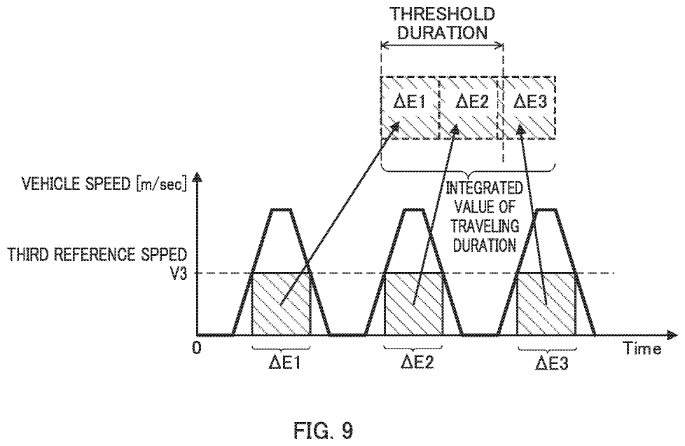

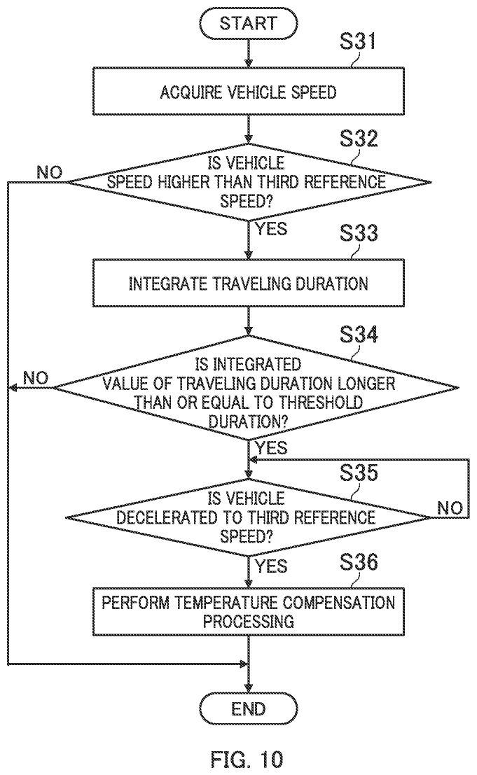

Now, the configuration of sonar ECU 20 according to Embodiment 4 will be described below with reference to FIGS. 9 and 10. Sonar ECU 20 (correction amount calculator 20b and correction amount setter 20c) according to this embodiment has a feature in integrating a duration during which, from when vehicle C starts to travel (e.g., from when vehicle C is turned on with a key), vehicle C travels at a speed higher than a third reference speed (hereinafter, this duration is also referred to as “traveling duration”), determining a correction amount by using a detected temperature detected when the integrated value of the traveling duration becomes longer than or equal to a threshold duration, and setting the correction amount for ultrasound wave sensor 10.

The “third reference speed” herein is substantially the same speed as the “first reference speed” described in Embodiment 1 and is 20 to 25 km/h, for example. In addition, the “threshold duration” is 3 to 15 minutes, for example, and may be the waiting time until performing the temperature compensation processing calculated by the method described above in Embodiment 3.

FIG. 9 is an explanatory diagram of the temperature compensation processing performed by sonar ECU 20 according to this embodiment. In FIG. 9, the horizontal axis represents an elapsed time after the time point at which vehicle C is turned on with a key, and the vertical axis presents the speed of vehicle C. Note that, as an example, FIG. 9 illustrates a change in the speed when vehicle C stops repeatedly due to a traffic jam or traffic lights.

As described above, in a case where vehicle C is heated in a parking lot under a burning sun, temperature sensor 15 is incapable of detecting an accurate outside air temperature at the start of traveling of vehicle C. Thus, the timing for determining the correction amount of the object determination threshold is preferably after temperature sensor 15 has been cooled by traveling wind and become to function normally.

However, if the timing for determining the correction amount of the object determination threshold is simply set as a timing at which the traveling duration during which vehicle C travels at a speed higher than or equal to the reference speed becomes longer than or equal to the threshold duration, vehicle C is incapable of traveling continuously for a long time due to a traffic jam or traffic lights, and, in a case where the traveling duration of a single time does not exceed the threshold duration, the object determination threshold is not corrected for a long time. Even in a case where vehicle C is incapable of traveling continuously due to a traffic jam or traffic lights, however, if vehicle C is repeatedly subjected to fresh outside air along with traveling, temperature sensor 15 radiates heat accumulatively.

Thus, sonar ECU 20 (correction amount setter 20c) according to this embodiment is configured to integrate the traveling duration during which, from when vehicle C starts to travel (e.g., from when vehicle C is turned on with a key), vehicle C travels at a speed higher than the third reference speed (ΔE1, ΔE2, and ΔE3 in FIG. 9), and to perform the temperature compensation processing when the integrated traveling duration becomes longer than or equal to the threshold duration. This enables earlier temperature compensation processing after temperature sensor 15 has become to function normally.

At this time, sonar ECU 20 (correction amount setter 20c) preferably determines the correction amount, after the integrated value of the traveling duration during which vehicle C travels at a speed higher than the third reference speed becomes longer than or equal to the threshold duration, at a timing at which vehicle C is decelerated to the third reference speed (>the reference speed for causing ultrasound wave sensor 10 to start to operate). Thus, the temperature compensation processing can be performed as early as possible and immediately before ultrasound wave sensor 10 needs to start to operate.

Note that, at this time, sonar ECU 20 may change a time range of the threshold duration on the basis of a change in the speed of vehicle C during a time slot in which vehicle C travels at a speed higher than the third reference speed. For example, in a case where the speed when vehicle C travels at a speed higher than the third reference speed is largely higher than the third reference speed, sonar ECU 20 may change the time range of the threshold duration to a short duration in accordance with the speed. In addition, in a case of using the method described above in Embodiment 3, if, due to traveling at a high speed, a measured temperature change rate is higher than the temperature change rate at the time the threshold duration is initially calculated, sonar ECU 20 may change the time range of the threshold duration to a short duration in accordance with the most recent temperature change rate.

In addition, sonar ECU 20 may initialize the integrated value of the traveling duration every time the temperature compensation processing is performed, and may repeatedly perform the temperature compensation processing while vehicle C is traveling.

FIG. 10 is a flowchart illustrating an example of an operation of sonar ECU 20 according to this embodiment.

In step S31, sonar ECU 20 acquires the speed of vehicle C from vehicle ECU 40.

In step S32, sonar ECU 20 determines whether the speed of vehicle C is higher than the third reference speed. If the speed of vehicle C is higher than the third reference speed (S32: YES), sonar ECU 20 advances the process to step S33; if the speed of vehicle C is lower than or equal to the third reference speed (S32: NO), the sonar ECU 20 ends the process in the flowchart in FIG. 10 without performing any processing.

In step S33, sonar ECU 20 updates the integrated value of the traveling duration that is currently stored in the storage.

In step S34, sonar ECU 20 determines whether the integrated value of the traveling duration becomes longer than or equal to the threshold duration. If the integrated value of the traveling duration becomes longer than or equal to the threshold duration (S34: YES), sonar ECU 20 advances the process to step S35; if the integrated value of the traveling duration is not longer than or equal to the threshold duration (S34: NO), sonar ECU 20 ends the process in the flowchart in FIG. 10 without performing any processing.

In step S35, sonar ECU 20 determines whether vehicle C is decelerated to the third reference speed, and waits for vehicle C to be decelerated to the third reference speed (S35: NO). When vehicle C is decelerated to the third reference speed (S35: YES), sonar ECU 20 advances the process to step S36.

In step S36, sonar ECU 20 acquires information regarding the detected temperature from temperature sensor 15, and performs the temperature compensation processing on the basis of the detected temperature.

Sonar ECU 20 according to this embodiment, for example, repeatedly performs the operation in this flowchart at predetermined time intervals (e.g., intervals of 100 ms) while vehicle C is traveling. The above description mainly illustrates the timing at which sonar ECU 20 sets the correction amount of the object determination threshold. However, the timing at which sonar ECU 20 calculates the correction amount is not necessarily the same timing with the timing at which sonar ECU 20 sets the correction amount. In the flowchart illustrated in FIG. 10, the information regarding the detected temperature is acquired after vehicle C has been decelerated to the third reference speed. However, the correction amount calculation processing can be performed independently of the correction amount setting processing. Thus, for example, sonar ECU 20 may repeat calculation of the correction amount of the object determination threshold at predetermined time intervals (e.g., intervals of 1 s), and sonar ECU 20 may set the most recent correction amount at the timing of step S36 for ultrasound wave sensor 10, for the following reason. Since the transition of the detected temperature is typically gradual, even if the time point for acquiring the detected temperature and calculating the correction amount changes from the timing immediately before the correction amount setting to the timing 1 second before the correction amount setting, the result of correction is not largely different. The time from when vehicle C is decelerated to the third reference speed until when ultrasound wave sensor 10 starts to operate is short, and thus, by separately performing the correction amount calculation processing in advance, a more inexpensive processing apparatus can implement the function.

[Effects]

As described above, sonar ECU 20 according to this embodiment integrates the traveling duration during which, from when vehicle C starts to travel, vehicle C travels at a speed higher than the third reference speed, determines the correction amount of the object determination threshold when the integrated value of the traveling duration becomes longer than or equal to the threshold duration, and sets the correction amount for ultrasound wave sensor 10.

Thus, for example, even if temperature sensor 15 is overheated when vehicle C starts to travel, the temperature compensation processing can be performed by using the detected temperature from temperature sensor 15 after temperature sensor 15 has radiated heat. In particular, correction amount setter 20c according to this embodiment determines the timing for performing the temperature compensation processing on the basis of the integrated value of the traveling duration during which vehicle C travels at a speed higher than the third reference speed, and thus, even in a case where vehicle C intermittently travels or stops (e.g., in a case where vehicle C travels on a jammed road), it is possible to prevent a situation where the temperature compensation processing is not performed for a long time.

### Embodiment 5

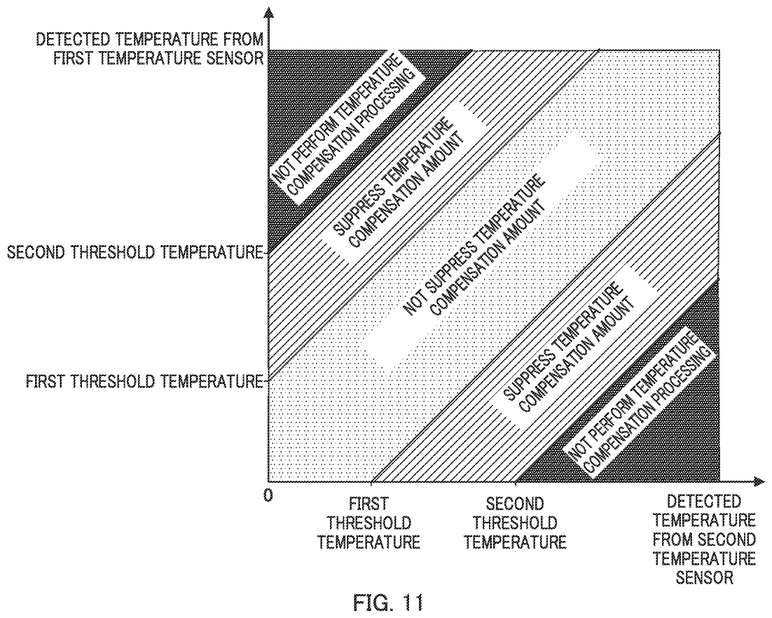

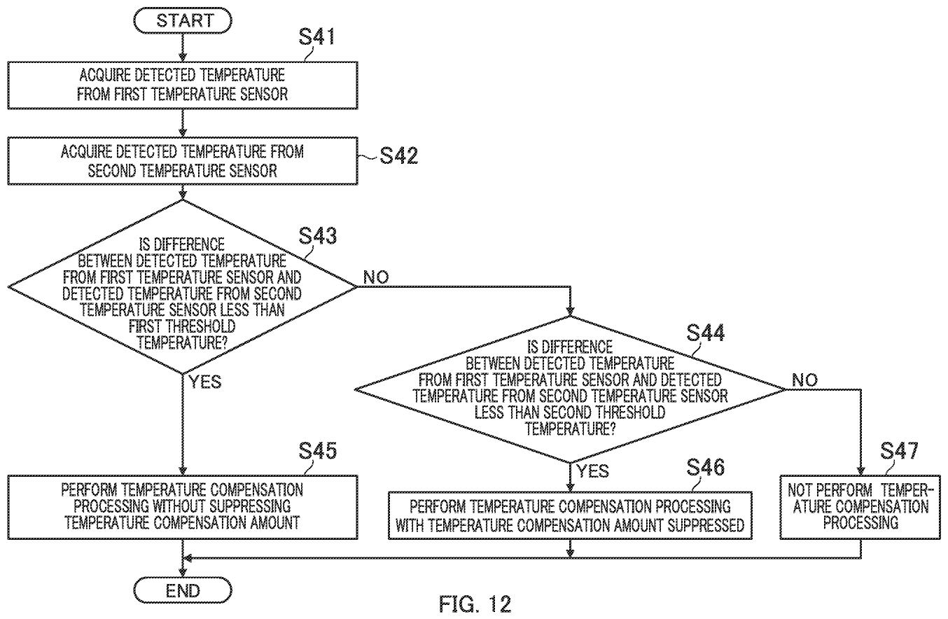

Now, the configuration of sonar ECU 20 according to Embodiment 5 will be described below with reference to FIGS. 11 and 12. Sonar ECU 20 (correction amount calculator 20b and correction amount setter 20c) according to this embodiment has a feature in determining whether a detected temperature detected by temperature sensor 15 that is built in ultrasound wave sensor 10 is normal, and, if the detected temperature is likely to be abnormal, suppressing a temperature compensation amount (i.e., the correction amount) of the object determination threshold.

Vehicle C may travel in various environments, and temperature sensor 15 in ultrasound wave sensor 10 is provided to be exposed to the outside of vehicle C. While vehicle C is traveling, due to water splash on the road, water drops may be attached to temperature sensor 15, or, due to snow falling, ice and snow may be attached thereto. In addition to ice and snow, direct sunlight, exhaust gas of other vehicles traveling around vehicle C, and the like are likely to influence temperature sensor 15. If ice and snow, direct sunlight, exhaust gas of other vehicles traveling around vehicle C, or the like influences temperature sensor 15 as above, the detected temperature detected by temperature sensor 15 may differ from the actual outside air temperature around vehicle C. As a result, the object determination threshold may be corrected to an inappropriate value, which may cause erroneous detection or detection delay of ultrasound wave sensor 10. Sonar ECU 20 according to this embodiment can prevent such a situation.

FIG. 11 is an explanatory diagram of an operation of sonar ECU 20 according to this embodiment.

By using the detected temperature from second temperature sensor 30 provided at such a position so as not to be exposed to the outside of vehicle C for comparison, sonar ECU 20 according to this embodiment determines whether the detected temperature detected by temperature sensor 15 (referred to as “first temperature sensor 15” for convenience of description in this embodiment) that is built in ultrasound wave sensor 10 is normal.

Note that sonar ECU 20 according to this embodiment acquires temperature information regarding the outside air temperature from each of first temperature sensor 15 and second temperature sensor 30.

In this embodiment, temperature sensor 15 that is built in ultrasound wave sensor 10 is referred to as “first temperature sensor 15” for convenience of description.

Second temperature sensor 30 herein is, for example, a temperature sensor that is included in an air-conditioning apparatus or intake apparatus (either is not illustrated) of vehicle C and that detects the outside air temperature. Although being inside the exterior of vehicle C and not exposed to the outside, second temperature sensor 30 is provided at a position appropriate for measuring the outside air temperature (e.g., in an air passage of the air-conditioning apparatus for introducing air to the inside of the vehicle from the outside of the vehicle or an intake filter part of the intake apparatus). Thus, unlike first temperature sensor 15, second temperature sensor 30 is unlikely to be influenced by ice and snow attached thereto, direct sunlight, exhaust gas of other vehicles, or the like. That is, compared with first temperature sensor 15, second temperature sensor 30 is advantageous in measuring the outside air temperature stably, although the responsivity to the change in the outside air temperature around vehicle C is lower. Second temperature sensor 30 may be any temperature sensor that is inside the exterior of the vehicle body and is suitable for measuring the outside air temperature. Thus, second temperature sensor 30 is not limited to one attached to the air-conditioning apparatus or the intake apparatus but may be a temperature sensor attached to another apparatus or may be an independent temperature sensor not attached to another apparatus. However, using an existing temperature sensor produces an effect of suppressing the entire cost, and thus, this embodiment describes a configuration of using temperature information obtained by the temperature sensor attached to the air-conditioning apparatus or the intake apparatus.

On the other hand, since first temperature sensor 15 is provided at such a position as to be exposed to the outside of vehicle C, the responsivity to the change in the outside air temperature around vehicle C is high. For example, if vehicle C enters a tunnel where the outside air temperature is low, first temperature sensor 15 can detect an accurate temperature at a relatively early stage.

Sonar ECU 20 according to this embodiment in a normal state (which means, in this embodiment, a state where the difference between the detected temperature from first temperature sensor 15 and the detected temperature from second temperature sensor 30 is less than a first threshold temperature), as described in the basic configuration of ultrasonic object detecting apparatus 1, determines the correction amount of the object determination threshold on the basis of the detected temperature from first temperature sensor 15. In this case, for example, by referring to a correction data table that is stored in advance in the storage (e.g., the ROM) of sonar ECU 20 by using the detected temperature from first temperature sensor 15 as the reference temperature, sonar ECU 20 acquires a correction amount corresponding to the detected temperature from first temperature sensor 15 and sets the correction amount for ultrasound wave sensor 10 without modifying it.

However, sonar ECU 20 (correction amount calculator 20b) according to this embodiment determines whether the difference between the detected temperature from first temperature sensor 15 and the detected temperature from second temperature sensor 30 is greater than or equal to the first threshold temperature, and if the difference is greater than or equal to the first threshold temperature, sonar ECU 20 modifies the correction amount of the object determination threshold such that the temperature compensation amount for the reference value of the object determination threshold is suppressed more than in a case where the difference is less than the first threshold temperature (i.e., in a normal state). Specifically, for example, if the difference is greater than or equal to the first threshold temperature, by referring to the correction data table, sonar ECU 20 acquires the correction amount corresponding to the detected temperature from first temperature sensor 15 and then modifies the correction amount to be smaller and sets the correction amount for ultrasound wave sensor 10. Note that, in the correction data table, for example, by using the object determination threshold for an average outside air temperature (e.g., 25° C.) as the reference value, the correction amount for each temperature from the reference value is set, and to reduce the correction amount means to suppress the temperature compensation amount.

This processing is performed in order to prevent the correction amount of the object determination threshold from being determined on the basis of an abnormal temperature detected if first temperature sensor 15 is influenced by, for example, rainwater attached thereto. That is, correction amount calculator 20b according to this embodiment can prevent abnormal correction of the object determination threshold in accordance with abnormality of the detected temperature from first temperature sensor 15.

In addition, if the difference between the detected temperature from first temperature sensor 15 and the detected temperature from second temperature sensor 30 is greater than or equal to the first threshold temperature, sonar ECU 20 (correction amount calculator 20b) according to this embodiment is configured to further determine whether the difference is greater than or equal to a second threshold temperature (note that the second threshold temperature >the first threshold temperature), and, if the difference is greater than or equal to the second threshold temperature, to not perform the temperature compensation processing for the object determination threshold (see FIG. 11) for the following reason. If the difference between the detected temperature from first temperature sensor 15 and the detected temperature from second temperature sensor 30 is extraordinarily large, the detected temperature from first temperature sensor 15 is assumed to be based on attached matter such as ice and snow, not on the outside air temperature around vehicle C. That is, the above configuration can prevent obviously incorrect temperature compensation.

Note that the threshold temperature for the difference between the detected temperature from first temperature sensor 15 and the detected temperature from second temperature sensor 30 is set to the same value in a case where the detected temperature from second temperature sensor 30 is higher than the detected temperature from first temperature sensor 15 and in a case where the detected temperature from second temperature sensor 30 is lower than the detected temperature from first temperature sensor 15 in FIG. 11. However, the threshold temperature may alternatively be set to different values in a case where the detected temperature from second temperature sensor 30 is higher than the detected temperature from first temperature sensor 15 and in a case where the detected temperature from second temperature sensor 30 is lower than the detected temperature from first temperature sensor 15.

FIG. 12 is a flowchart illustrating an operation of sonar ECU 20 according to this embodiment.

In step S41, sonar ECU 20 acquires information regarding the detected temperature from first temperature sensor 15.

In step S42, sonar ECU 20 acquires information regarding the detected temperature from second temperature sensor 30.

In step S43, sonar ECU 20 determines whether the difference between the detected temperature from first temperature sensor 15 and the detected temperature from second temperature sensor 30 is less than the first threshold temperature. If the difference is less than the first threshold temperature (S43: YES), sonar ECU 20 advances the process to step S45; if the difference is greater than or equal to the first threshold temperature (S43: NO), sonar ECU 20 advances the process to step S44.

In step S44, sonar ECU 20 determines whether the difference between the detected temperature from first temperature sensor 15 and the detected temperature from second temperature sensor 30 is less than the second threshold temperature. If the difference is less than the second threshold temperature (S44: YES), sonar ECU 20 advances the process to step S46; if the difference is greater than or equal to the second threshold temperature (S44: NO), sonar ECU 20 advances the process to step S47.

In step S45, sonar ECU 20 performs the temperature compensation processing without suppressing the temperature compensation amount. At this time, for example, sonar ECU 20 sets a correction amount for ultrasound wave sensor 10 without modifying it, the correction amount being determined by referring to the correction data table on the basis of the detected temperature from first temperature sensor 15.

In step S46, sonar ECU 20 performs the temperature compensation processing with the temperature compensation amount suppressed. At this time, for example, sonar ECU 20 modifies a correction amount to a half value, the correction amount being determined by referring to the correction data table on the basis of the detected temperature from first temperature sensor 15, and sets the correction amount for ultrasound wave sensor 10.

In step S47, sonar ECU 20 determines that the temperature compensation processing is not to be performed. At this time, for example, the sonar ECU 20 sets ultrasound wave sensor 10 in a non-operating state in order to prevent erroneous detection of ultrasound wave sensor 10.

Sonar ECU 20 according to this embodiment, for example, repeatedly performs the operation in this flowchart at predetermined time intervals (e.g., intervals of 1 s) while vehicle C is traveling. Note that the correction amount calculation processing and the correction amount setting processing are performed concurrently in this flowchart. However, the correction amount calculation processing and the correction amount setting processing can be performed separately and independently. Thus, for example, to match with the timing for setting the correction amount described in Embodiment 1, the correction amount may be set at a timing at which the condition on the vehicle speed is satisfied.

[Effects]

As described above, sonar ECU 20 according to this embodiment determines whether the difference between the detected temperature from first temperature sensor 15 and the detected temperature from second temperature sensor 30 is greater than or equal to the first threshold temperature, and, if the difference is greater than or equal to the first threshold temperature, determines the correction amount of the object determination threshold to be set for ultrasound wave sensor 10 such that the temperature compensation amount for the reference value of the object determination threshold (e.g., a value at a normal temperature) becomes smaller than that in a case where the difference is less than the first threshold temperature.

Thus, while the responsivity of temperature compensation to the change in the outside air temperature around vehicle C is maintained, it is possible to prevent the object determination threshold from being corrected to an abnormal value due to a disturbance factor (e.g., ice and snow attached to ultrasound wave sensor 10) other than the outside air temperature.

### Embodiment 6

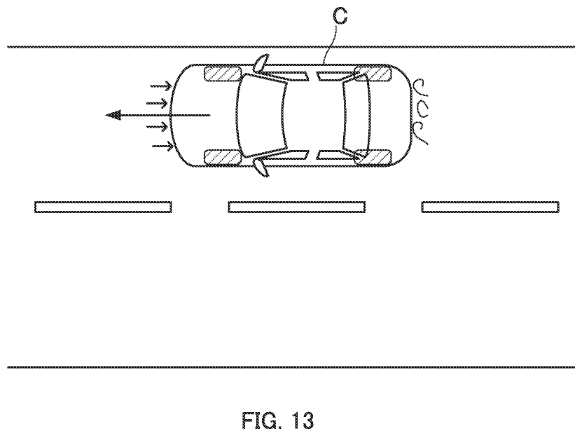

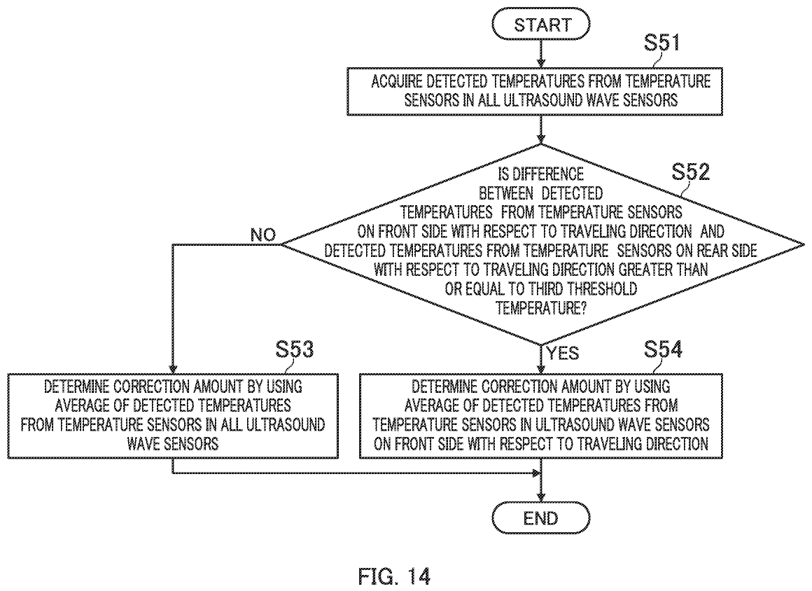

Now, the configuration of sonar ECU 20 according to Embodiment 6 will be described below with reference to FIGS. 13 and 14. Sonar ECU 20 (correction amount calculator 20b) according to this embodiment has a feature in switching, depending on situation, a detected temperature to be referred to at the time of the temperature compensation processing from among detected temperatures detected by temperature sensors 15A to 15H that are built in plural ultrasound wave sensors 10A to 10H, respectively, provided in vehicle C.

Vehicle C may travel in various environments, and a traveling route of vehicle C may include an underground parking lot or a tunnel. In such an underground parking lot or a tunnel, a temperature difference may be present in the outside air temperature around vehicle C from the outdoor traveling route in many cases (during summer in particular, the temperature in such an environment is lower than that in the outdoor environment). Thus, the outside air temperature around vehicle C may suddenly change while vehicle C is traveling. In such a case, correction of the object determination threshold to be set for ultrasound wave sensor 10 may delay, which may cause obstacle erroneous detection or obstacle detection failure. Correction amount calculator 20b according to this embodiment can prevent such a situation.

FIG. 13 is an explanatory diagram of an operation of sonar ECU 20 according to this embodiment.

In a normal state (which means a case where the outside air temperature around vehicle C does not suddenly change in this embodiment), sonar ECU 20 (correction amount calculator 20b) according to this embodiment determines the correction amount of the object determination threshold by referring to detected temperatures from all temperature sensors 15A to 15H. At this time, correction amount calculator 20b determines the correction amount of the object determination threshold by using, for example, the average of the detected temperatures detected by temperature sensors 15A to 15H, or the second lowest detected temperature (refer to Embodiment 7 described later) of the detected temperatures detected by temperature sensors 15A to 15H. Note that the same correction amount of the object determination threshold is typically set for plural ultrasound wave sensors 10A to 10H.

Note that under a predetermined condition, sonar ECU 20 (correction amount calculator 20b) according to this embodiment determines the correction amount of the object determination threshold on the basis of only detected temperatures detected by temperature sensors 15 that are built in ultrasound wave sensors 10 provided on the front side with respect to the traveling direction of vehicle C among plural ultrasound wave sensors 10A to 10H.

The “predetermined condition” herein is typically a case where, while vehicle C is traveling, the outside air temperature around vehicle C is assumed to have suddenly changed or may suddenly change. Specifically, sonar ECU 20 determines that the following case corresponds to the “predetermined condition”. For example, a temperature difference between the detected temperatures indicated by temperature sensors 15 (e.g., one of temperature sensors 15A to 15D) that are built in ultrasound wave sensors 10 (e.g., one of ultrasound wave sensors 10A to 10D) provided on the front side with respect to the traveling direction of vehicle C among plural ultrasound wave sensors 10A to 10H and the detected temperatures indicated by temperature sensors 15 (e.g., one of temperature sensors 15E to 15H) that are built in ultrasound wave sensors 10 (e.g., one of ultrasound wave sensors 10E to 10H) provided on the rear side with respect to the traveling direction of vehicle C among plural ultrasound wave sensors 10A to 10H is greater than or equal to a third threshold temperature (e.g., 5° C.). Note that the traveling direction is not limited to ahead of the vehicle but may be behind the vehicle when the vehicle is moving backward. That is, when the vehicle is moving backward, ultrasound wave sensors 10 provided on the front side with respect to the traveling direction of vehicle C are ultrasound wave sensors 10E to 10H, and ultrasound wave sensors 10 provided on the rear side with respect to the traveling direction of vehicle C are ultrasound wave sensors 10A to 10D. Information on the traveling direction of vehicle C can be acquired via the on-board network 100.

If sonar ECU 20 according to this embodiment determines that the current situation corresponds to the “predetermined condition”, sonar ECU 20 determines the correction amount of the object determination threshold by using only the detected temperatures from temperature sensors 15 (e.g., temperature sensors 15A to 15D) that are built in ultrasound wave sensors 10 (e.g., ultrasound wave sensors 10A to 10D) provided on the front side with respect to the traveling direction of vehicle C. Note that, in this case, sonar ECU 20 determines the correction amount of the object determination threshold by using, for example, the average or the second lowest detected temperature of the detected temperatures detected by temperature sensors 15 (e.g., temperature sensors 15A to 15D) in ultrasound wave sensors 10 (e.g., ultrasound wave sensors 10A to 10D) provided on the front side with respect to the traveling direction of vehicle C.

Sonar ECU 20 according to this embodiment performs the above processing because, in a case where vehicle C enters an underground parking lot or a tunnel having a temperature difference from the outdoor environment while traveling, the detected temperatures from temperature sensors 15 that are built in ultrasound wave sensors 10 provided on the front side with respect to the traveling direction of vehicle C converge to the actual outside air temperature around vehicle C earlier than the detected temperatures from temperature sensors 15 that are built in ultrasound wave sensors 10 provided on the rear side with respect to the traveling direction of vehicle C. The reason for this is that air in a region where vehicle C enters directly hits the side surfaces of the front side with respect to the traveling direction of vehicle C along with traveling of vehicle C, whereas vortices are formed around the side surfaces of the rear side with respect to the traveling direction of vehicle C, and part of outdoor air before vehicle C enters the tunnel or the like is retained thereon. In addition, in a case where a freight car moves backward to enter or approach a refrigeration facility for loading, such as a liquefied natural gas storage place or a cold storage, from the rear part of the vehicle body, cold air directly hits the rear surface of vehicle C, whereas part of not-cooled air is retained on the front surface of vehicle C.

Note that sonar ECU 20 according to this embodiment detects a state in which vehicle C enters an underground parking lot. Thus, for example, sonar ECU 20 may acquire, from vehicle ECU 40, traveling-route slope information indicated by a slope sensor (not illustrated) mounted on vehicle C, information on the location and elevation of vehicle C indicated by a global positioning system (GPS) receiver (not illustrated) mounted on vehicle C, or information regarding the location of a tunnel or a refrigeration facility, and, on the basis of such information, may determine whether the current situation corresponds to the above “predetermined condition”. In this case, for example, on the basis of such information, if the slope of the traveling route on which vehicle C is traveling is greater than to a threshold angle, or if the elevation of the traveling route on which vehicle C is traveling changes by a threshold elevation or more within a predetermined distance or a predetermined duration, correction amount calculator 20b may determine that the current situation corresponds to the above “predetermined condition”, or, on the basis of the fact that vehicle C is near the refrigeration facility, may determine that the current situation corresponds to the above “predetermined condition”.

FIG. 14 is a flowchart illustrating an operation of sonar ECU 20 according to this embodiment. Note that this operation is performed while vehicle C is moving forward.

In step S51, sonar ECU 20 acquires information regarding the detected temperatures from temperature sensors 15A to 15H from all ultrasound wave sensors 10A to 10H, respectively, mounted on vehicle C.

In step S52, sonar ECU 20 determines whether the difference between the detected temperatures from temperature sensors 15A to 15D in ultrasound wave sensors 10A to 10D on the front side with respect to the traveling direction and the detected temperatures from temperature sensors 15E to 15H in ultrasound wave sensors 10E to 10H on the rear side with respect to the traveling direction is greater than or equal to the third threshold temperature. If the difference is less than the third threshold temperature (S52: NO), sonar ECU 20 advances the process to step S53; if the difference is greater than or equal to the third threshold temperature (S52: YES), sonar ECU 20 advances the process to step S54.

In step S53, sonar ECU 20 determines the correction amount of the object determination threshold by using the average of the detected temperatures from temperature sensors 15A to 15H in all ultrasound wave sensors 10A to 10H and sets the correction amount for ultrasound wave sensors 10A to 10H.

In step S54, sonar ECU 20 determines the correction amount of the object determination threshold by using the average of the detected temperatures from temperature sensors 15A to 15D in ultrasound wave sensors 10A to 10D on the front side with respect to the traveling direction and sets the correction amount for ultrasound wave sensors 10A to 10H. Note that, while vehicle C is moving backward, sonar ECU 20 determines the correction amount of the object determination threshold by using the average of the detected temperatures from temperature sensors 15E to 15H in ultrasound wave sensors 10E to 10H on the front side with respect to the traveling direction. The traveling direction of vehicle C is acquired via the on-board network 100.

Sonar ECU 20 according to this embodiment, for example, repeatedly performs the operation in this flowchart at predetermined time intervals (e.g., intervals of 1 s) while vehicle C is traveling. Note that the correction amount calculation processing and the correction amount setting processing are performed concurrently in this flowchart. However, the correction amount calculation processing and the correction amount setting processing can be performed separately and independently. Thus, for example, to match with the timing for setting the correction amount described in Embodiment 1, the correction amount may be set at a timing at which the condition on the vehicle speed is satisfied.

[Effects]

As described above, under the predetermined condition, sonar ECU 20 according to this embodiment determines the correction amount of the object determination threshold by selectively using the detected temperatures from temperature sensors 15 that are built in ultrasound wave sensors 10 provided on the front side with respect to the traveling direction of vehicle C from among temperature sensors 15A to 15H that are built in plural ultrasound wave sensors 10A to 10H, respectively, and on the basis of the detected temperatures detected by temperature sensors 15.

Thus, even if vehicle C enters or exits from an underground parking lot or a tunnel having a temperature difference from the outdoor environment, the temperature compensation processing for the object determination threshold can be performed so as to correspond to the outside air temperature early.

### Embodiment 7

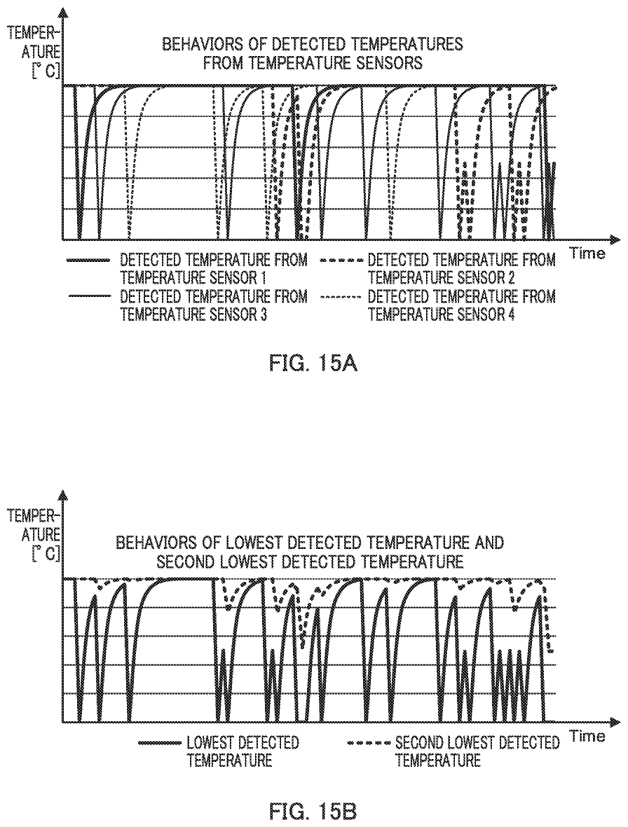

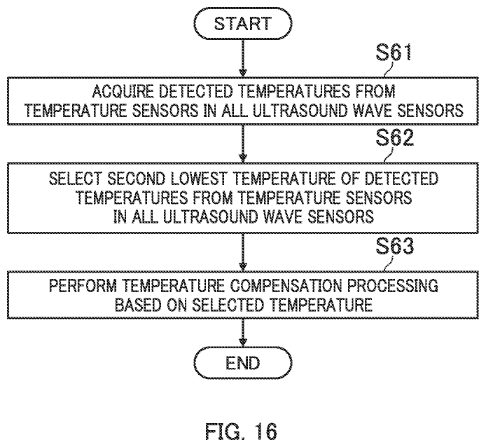

Now, the configuration of sonar ECU 20 according to Embodiment 7 will be described below with reference to FIGS. 15A, 15B, and 16. Sonar ECU 20 (correction amount calculator 20b) according to this embodiment has a feature in selecting the second lowest detected temperature from among detected temperatures detected by temperature sensors 15A to 15H in plural ultrasound wave sensors 10A to 10H, respectively, and determining the correction amount of the object determination threshold on the basis of the second lowest detected temperature.

Vehicle C may travel in various environments, and ultrasound wave sensor 10 is provided to be exposed to the outside of vehicle C. While vehicle C is traveling, due to water splash on the road, water drops may be attached to temperature sensor 15 built in ultrasound wave sensor 10, or, due to snow falling, ice and snow may be attached thereto. In addition, depending on the driving state of vehicle C, temperature sensor 15 may be thermally influenced by a heat source (e.g., engine or muffler) mounted on vehicle C. In such a case, the object determination threshold may be corrected to an incorrect value, and ultrasound wave sensor 10 may cause obstacle erroneous detection or obstacle detection failure. Correction amount calculator 20b according to this embodiment can prevent such a situation.

FIGS. 15A and 15B illustrate examples of behaviors of detected temperatures from temperature sensors 15 in plural ultrasound wave sensors 10, respectively, mounted on vehicle C. For example, in a case where vehicle C is hit by snow or sleet, individual ultrasound wave sensors 10 may or may not be hit by snow or sleet at random. In addition, if ultrasound wave sensors 10 are hit by snow or sleet, it may or may not be attached to ultrasound wave sensors 10. FIG. 15A illustrates behaviors of detected temperatures from temperature sensors 15 in four ultrasound wave sensors 10 among plural ultrasound wave sensors 10 mounted on vehicle C. FIG. 15B illustrates a graph obtained by selectively connecting, with lines, the lowest detected temperature (thick line) and the second lowest detected temperature (broken line) at the respective timings among the detected temperatures from four temperature sensors 15 illustrated in FIG. 15A.

As described above, the detected temperature from temperature sensor 15 that is built in ultrasound wave sensor 10 may indicate a value different from the actual outside air temperature due to a disturbance factor (e.g., ice and snow attached thereto or the heat source mounted on vehicle C). For example, in a case where ultrasound wave sensor 10 is influenced by ice and snow attached thereto, when snow or sleet hits and is attached to ultrasound wave sensor 10, as illustrated in FIG. 15A, the detected temperature from temperature sensor 15 that is built in ultrasound wave sensor 10 suddenly decreases to the chilling temperature. However, if snow or sleet melts to fall down or does not hit, the detected temperature gradually increases and converges toward the outside air temperature.

In a case where ultrasound wave sensors 10 are influenced by the heat source mounted on vehicle C, the lowest temperature of temperatures detected by temperature sensors 15A to 15H that are included in plural ultrasound wave sensors 10A to 10H, respectively, mounted on vehicle C may be the least thermally influenced by the heat source (e.g., engine or muffler) mounted on vehicle C and may be the closest to the outside air temperature, however, in a case where ultrasound wave sensors 10 influenced by ice and snow attached thereto, the lowest temperature may be the most distant from the outside air temperature and the most inappropriate temperature. Typically, if an event that changes at random is assumed, the temporal change in the lowest temperature of temperatures detected by plural temperature sensors 15 may be a mixture of transitional sudden changes in many cases, whereas the second lowest temperature is a mixture of convergence to a stationary state and has more stable behavior than the lowest temperature (see FIG. 15B). In addition, in a case where a thermal influence of the heat source (e.g., engine or muffler) mounted on vehicle C is assumed, ultrasound wave sensors 10 are provided at positions away from one another, and the number of thermally influenced temperature sensors 15 is limited. Thus, even if the second lowest temperature is selected, the case where the second lowest temperature is selected may be expected to be not largely different from the case where the lowest temperature is selected.

From the above viewpoint, sonar ECU 20 (correction amount calculator 20b) according to this embodiment selects the second lowest detected temperature of the detected temperatures from temperature sensors 15A to 15H in plural ultrasound wave sensors 10A to 10H, respectively, mounted on vehicle C and determines the correction amount of the object determination threshold from the detected temperature.

Note that, among temperature sensors 15A to 15H in plural ultrasound wave sensors 10A to 10H, respectively, temperature sensor 15 indicating the second lowest detected temperature temporally changes as illustrated in FIG. 15B. Thus, when determining the correction amount of the object determination threshold, correction amount calculator 20b acquires the detected temperatures from temperature sensors 15A to 15H in plural ultrasound wave sensors 10A to 10H, respectively, and then determines the correction amount of the object determination threshold by using the second lowest detected temperature as the reference temperature.

FIG. 16 is a flowchart illustrating an operation of sonar ECU 20 according to this embodiment.

In step S61, sonar ECU 20 acquires information regarding the detected temperatures from temperature sensors 15A to 15H in plural ultrasound wave sensors 10A to 10H, respectively.

In step S62, sonar ECU 20 selects the second lowest temperature of the detected temperatures from temperature sensors 15A to 15H in plural ultrasound wave sensors 10A to 10H, respectively.

In step S63, sonar ECU 20 performs the temperature compensation processing by using the selected temperature.

Sonar ECU 20 according to this embodiment, for example, repeatedly performs the operation in this flowchart at predetermined time intervals (e.g., intervals of 1 s) while vehicle C is traveling. Note that the correction amount calculation processing and the correction amount setting processing are performed concurrently in this flowchart. However, the correction amount calculation processing and the correction amount setting processing can be performed separately and independently. Thus, for example, to match with the timing for setting the correction amount described in Embodiment 1, the correction amount may be set at a timing at which the condition on the vehicle speed is satisfied.

[Effects]

As described above, sonar ECU 20 according to this embodiment selects the second lowest detected temperature of the detected temperatures detected by temperature sensors 15A to 15H in plural ultrasound wave sensors 10A to 10H, respectively, and determines the correction amount of the object determination threshold on the basis of the second lowest detected temperature.

This enables the temperature compensation processing for the object determination threshold by using, as the reference, a temperature closer to the actual outside air temperature, and thus can increase the detection accuracy of an obstacle.

Note that this embodiment illustrates a case where sonar ECU 20 selects the second lowest detected temperature of the detected temperatures from temperature sensors 15A to 15H in all ultrasound wave sensors 10A to 10H mounted on vehicle C. However, in a case where a temperature sensor or temperature sensors with a high temperature-detection accuracy can be identified in advance from among temperature sensors 15A to 15H in all ultrasound wave sensors 10A to 10H mounted on vehicle C, sonar ECU 20 may narrow down temperature sensor 15 or temperature sensors 15 to be referred to from among temperature sensors 15A to 15H in ultrasound wave sensors 10A to 10H.

For example, while vehicle C is driving, if the outside air temperature around vehicle C is assumed to have suddenly changed, correction amount calculator 20b may refer to only the detected temperatures from temperature sensors 15 in ultrasound wave sensors 10 provided on the front side with respect to the traveling direction of vehicle C among ultrasound wave sensors 10A to 10H mounted on vehicle C, and, by using the second lowest detected temperature of these detected temperatures as the reference temperature, may determine the correction amount of the object determination threshold.

On the other hand, if ultrasound wave sensors 10 with a large heat generation amount in operation are used, sonar ECU 20 may refer to only the detected temperatures from temperature sensors 15 in ultrasound wave sensors 10 provided on the rear side with respect to the traveling direction of vehicle C, and, by using the second lowest detected temperature of these detected temperatures as the reference temperature, may determine the correction amount of the object determination threshold, for the following reason. Typically, while vehicle C is driving, ultrasound wave sensors 10 provided on the rear side with respect to the traveling direction of vehicle C are in a non-operating state.

### Embodiment 8

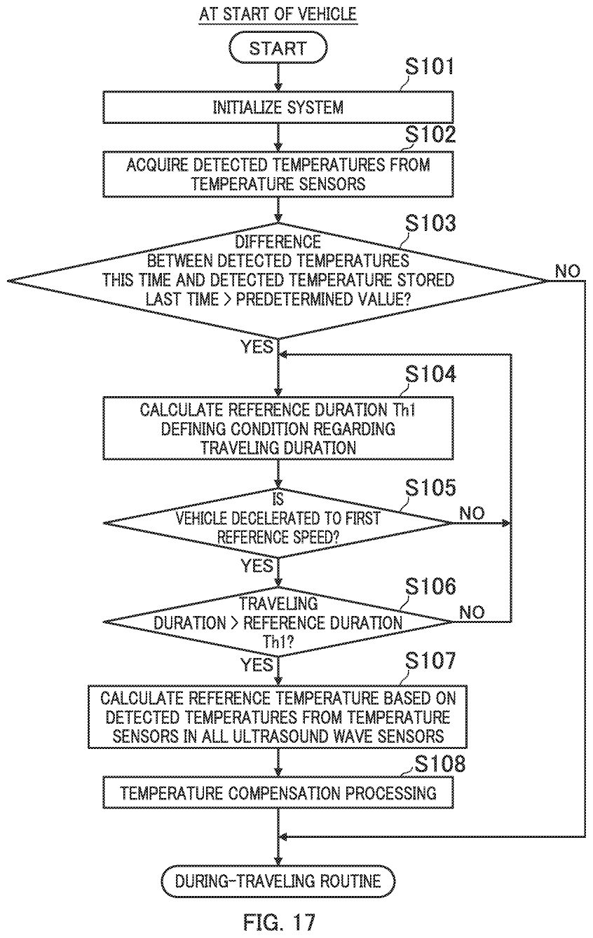

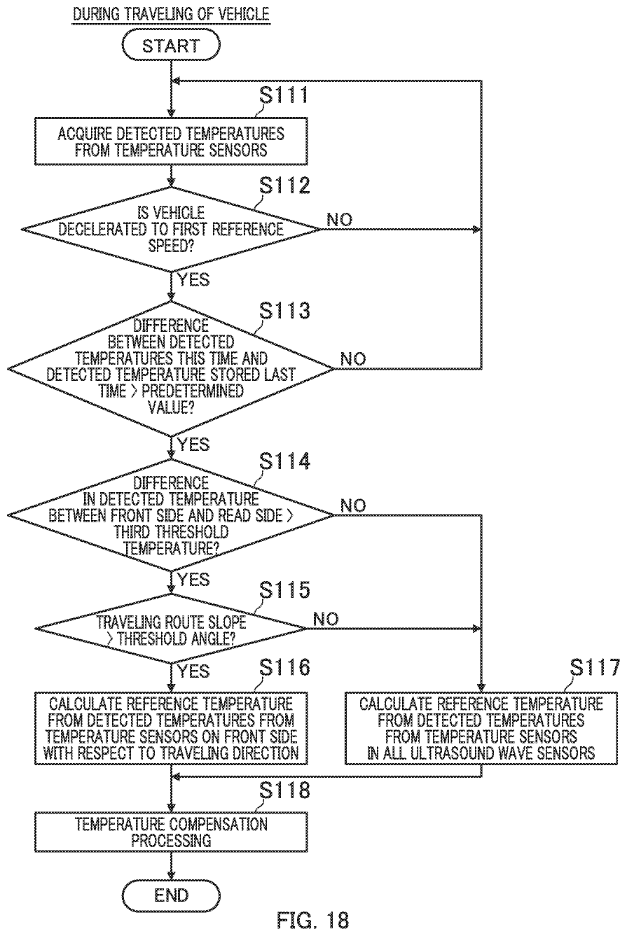

Now, the configuration of sonar ECU 20 according to Embodiment 8 will be described below with reference to FIGS. 17 and 18. This embodiment illustrates an example of a temperature compensation method obtained by combining the temperature compensation methods in the above embodiments.

FIG. 17 is a flowchart illustrating an operation started by sonar ECU 20 according to this embodiment when vehicle C is turned on with a key (e.g., when vehicle C is activated).

In step S101, first, sonar ECU 20 initializes a system.

In step S102, sonar ECU 20 acquires temperature information regarding the outside air temperature from temperature sensors 15A to 15H that are built in ultrasound wave sensors 10A to 10H mounted on vehicle C.

In step S103, sonar ECU 20 determines whether a difference between the detected temperatures (e.g., the average) detected in step S102 and the detected temperature detected the last time and stored in the RAM or the like is greater than a predetermined value (e.g., 5° C.). If the difference is greater than the predetermined value (S103: YES), sonar ECU 20 advances the process to step S104; if the difference is less than or equal to the predetermined value (S103: NO), sonar ECU 20 ends the process in the flowchart. Note that this processing is provided in order to skip the temperature compensation processing if the current outside air temperature is substantially equal to the detected temperature detected the last time.

In step S104, sonar ECU 20 calculates reference duration Th1 defining the condition regarding the traveling duration. Threshold duration Th1 is the reference duration described in Embodiment 1 for determining the duration during which vehicle C travels at a speed higher than the first reference speed. At this time, as described in Embodiment 3, for example, on the basis of the transition of the detected temperature from temperature sensor 15, sonar ECU 20 determines the time until the detected temperature from temperature sensor 15 converges to a temperature around the actual temperature, and sets the time as reference duration Th1.

In step S105, sonar ECU 20 determines whether vehicle C is decelerated to the first reference speed after having traveled at a speed higher than the first reference speed. If this traveling condition is satisfied (S105: YES), sonar ECU 20 advances the process to step S106; if this traveling condition is not satisfied (S105: NO), sonar ECU 20 returns the process to step S104 and performs substantially the same processing again. Note that this processing corresponds to the processing for determining the timing for performing temperature compensation described in Embodiment 1.

In step S106, sonar ECU 20 determines whether the traveling duration during which vehicle C travels until vehicle C is decelerated to the first reference speed after having been accelerated to a speed higher than the first reference speed is longer than reference duration Th1 calculated in step S104. If the traveling duration is longer than reference duration Th1 calculated in step S104 (S106: YES), sonar ECU 20 advances the process to step S107; if the traveling duration is shorter than or equal to reference duration Th1 calculated in step S104 (S106: NO), sonar ECU 20 returns the process to step S104 and performs substantially the same processing again.

In step S107, sonar ECU 20 acquires temperature information regarding the detected temperatures from temperature sensors 15A to 15H that are built in ultrasound wave sensors 10A to 10H, respectively, and calculates the reference temperature on the basis of this information. Note that, at this time, for example, sonar ECU 20 determines, as the reference temperature, the average of the detected temperatures from temperature sensors 15A to 15H that are built in plural ultrasound wave sensors 10A to 10H, respectively.

In step S108, by using the reference temperature calculated in step S107, sonar ECU 20 performs the temperature compensation processing for each of plural ultrasound wave sensors 10A to 10H. Note that, after having performed the temperature compensation processing, sonar ECU 20 transitions to an operation in the flowchart in FIG. 18.

Through the above process, from when vehicle C starts, the temperature compensation processing for ultrasound wave sensor 10 can be performed at an appropriate timing without unnecessarily repeating the temperature compensation processing.

FIG. 18 is a flowchart illustrating an operation performed by sonar ECU 20 according to this embodiment while vehicle C is traveling.

In step S111, sonar ECU 20 acquires temperature information regarding the outside air temperature from temperature sensors 15A to 15H that are built in ultrasound wave sensors 10A to 10H mounted on vehicle C.

In step S112, sonar ECU 20 determines whether vehicle C is decelerated to the first reference speed after having traveled at a speed higher than the first reference speed. If this traveling condition is satisfied (S112: YES), sonar ECU 20 advances the process to step S113; if this traveling condition is not satisfied (S112: NO), sonar ECU 20 returns the process to step S111 and performs substantially the same processing again.

In step S113, sonar ECU 20 determines whether a difference between the detected temperatures detected in step S111 and the detected temperature detected the last time and stored in the RAM or the like is greater than a predetermined value (e.g., 5° C.). If the difference is greater than the predetermined value (S113: YES), sonar ECU 20 advances the process to step S114; if the difference is less than or equal to the predetermined value (S113: NO), sonar ECU 20 returns the process to step S111 and performs substantially the same processing again.

In step S114, among temperature sensors 15A to 15H in plural ultrasound wave sensors 10A to 10H mounted on vehicle C, sonar ECU 20 calculates a difference between the detected temperatures from temperature sensors 15 in ultrasound wave sensors 10 provided on the front side with respect to the traveling direction and the detected temperatures from temperature sensors 15 in ultrasound wave sensors 10 provided on the rear side with respect to the traveling direction, and determines whether the difference is greater than the third threshold temperature (e.g., 5° C.). If the difference is greater than the third threshold temperature (S114: YES), sonar ECU 20 advances the process to step S115; if the difference is less than or equal to the third threshold temperature (S114: NO), sonar ECU 20 advances the process to step S117. Note that this processing is determination processing so as to correspond to a situation where the outside air temperature around vehicle C suddenly changes while vehicle C is traveling, as described in Embodiment 6.

In step S115, sonar ECU 20 determines whether the slope of the traveling route on which vehicle C is traveling is greater than a threshold angle. If the slope is greater than the threshold angle (S115: YES), sonar ECU 20 advances the process to step S116; if the slope is less than or equal to the threshold angle (S115: NO), sonar ECU 20 advances the process to step S117. Note that this processing is determination processing so as to correspond to a situation where the outside air temperature around vehicle C suddenly changes while vehicle C is traveling, as described in Embodiment 6.

In step S116, from among plural ultrasound wave sensors 10A to 10H mounted on vehicle C, sonar ECU 20 selects only temperature sensors 15A to 15D in ultrasound wave sensors 10A to 10D provided on the front side with respect to the traveling direction and calculates a reference temperature from the detected temperatures from temperature sensors 15A to 15D. Note that, at this time, for example, sonar ECU 20 calculates, as the reference temperature, the average of the detected temperatures from temperature sensors 15A to 15D in ultrasound wave sensors 10A to 10D provided on the front side with respect to the traveling direction.

In step S117, sonar ECU 20 determines a reference temperature from the detected temperatures from temperature sensors 15A to 15H in all plural ultrasound wave sensors 10A to 10H mounted on vehicle C. Note that, at this time, for example, sonar ECU 20 calculates, as the reference temperature, the average of the detected temperatures from temperature sensors 15A to 15H in all ultrasound wave sensors 10A to 10H.

In step S118, by using the reference temperature determined in step S116 or step S117, sonar ECU 20 performs the temperature compensation processing for each of plural ultrasound wave sensors 10A to 10H.

For example, the process in the flowchart in FIG. 18 is repeatedly performed at predetermined time intervals (e.g., intervals of 1 s) while vehicle C is traveling. Note that the correction amount calculation processing and the correction amount setting processing are performed concurrently in this flowchart. However, the correction amount calculation processing and the correction amount setting processing can be performed separately and independently. Thus, for example, to match with the timing for setting the correction amount described in Embodiment 1, the correction amount may be set at a timing at which the condition on the vehicle speed is satisfied.

Through the above process, even in a situation where the atmosphere temperature suddenly changes, temperature compensation for the object determination threshold can be performed appropriately.

### Other Embodiments

The present invention may be modified in various manners without being limited to the above embodiments.

The above embodiments illustrate various examples of temperature compensation performed by sonar ECU 20. However, the examples of temperature compensation performed by sonar ECU 20 illustrated in the embodiments may be implemented independently or in combination in various manners.

In addition, although the above embodiments illustrate, as an example, correction amount setter 20c correcting the object determination threshold, the target of temperature compensation may alternatively be the sensitivity to the reflection wave (i.e., a gain) of reception circuit 13. In this case, correction amount setter 20c may set the correction amount such that the sensitivity is increased as the outside air temperature is higher and the sensitivity is decreased as the outside air temperature is lower, in contrast to the case of correcting the object determination threshold.

Furthermore, although the functions of sonar ECU 20 are implemented by processing of the CPU in the above embodiments, some or all of the functions of sonar ECU 20 may alternatively be implemented by, in place of or in addition to processing of the CPU, processing of a digital signal processor (DSP) or a dedicated hardware circuit (e.g., an application-specific integrated circuit (ASIC) or a field-programmable gate array (FPGA)).

While various embodiments have been described herein above, it is to be appreciated that various changes in form and detail may be made without departing from the spirit and scope of the invention(s) presently or hereafter claimed.

### INDUSTRIAL APPLICABILITY

The correction amount setting apparatus according to an embodiment of the present disclosure can perform more appropriate temperature compensation processing.

### REFERENCE SIGNS LIST

C Vehicle
1 Ultrasonic object detecting apparatus
10A to 10H Ultrasound wave sensor
11 Transmitter/receiver
12 Drive circuit
13 Reception circuit
14 Controller
14a Transmission/reception controller
14b Communicator
14c Waveform memory
14d Threshold memory
14e Determiner
15A to 15H Temperature sensor (first temperature sensor)
20 Sonar ECU
20a Sensor operation commander
20b Correction amount calculator
20c Correction amount setter
30 Second temperature sensor
100 On-board network

1. A correction amount setting apparatus for setting a correction amount for at least one sound wave sensor that is mounted on a vehicle and that detects an obstacle by transmitting and receiving a sound wave, the correction amount being a correction amount of a sensitivity to a reflection wave or a threshold for determining whether an obstacle is present, the correction amount setting apparatus comprising:
a correction amount calculator that acquires information regarding a detected temperature from a temperature sensor that detects an outside air temperature around the vehicle and determines the correction amount based on the detected temperature; and
a correction amount setter that sets the correction amount for the at least one sound wave sensor,
wherein the correction amount setter sets the correction amount for the at least one sound wave sensor at a first timing, the first timing being a time at which, from start of traveling of the vehicle, the vehicle, after having been accelerated to a speed higher than a first reference speed, is decelerated to the first reference speed.

2. The correction amount setting apparatus according to claim 1,
wherein, after the correction amount has been set, when the speed of the vehicle is lower than or equal to a second reference speed, the at least one sound wave sensor performs an operation of detecting an obstacle, and
wherein the first reference speed is higher than the second reference speed.

3. The correction amount setting apparatus according to claim 2,
wherein the first reference speed is higher than or equal to 20 km/h and lower than or equal to 25 km/h, and
wherein the second reference speed is higher than or equal to 12 km/h and lower than or equal to 18 km/h.

4. The correction amount setting apparatus according to claim 1,
wherein the correction amount setter determines, at the first timing, whether a traveling duration during which vehicle travels at a speed higher than the first reference speed is longer than or equal to a reference duration,
wherein, when the traveling duration is longer than or equal to the reference duration, the correction amount setter sets the correction amount for the at least one sound wave sensor, and
wherein, when the traveling duration is shorter than the reference duration, the correction amount setter does not set the correction amount for the at least one sound wave sensor.

5. The correction amount setting apparatus according to claim 4,
wherein the correction amount setter determines a time range of the reference duration based on a transition of the detected temperature from the temperature sensor.

6. The correction amount setting apparatus according to claim 1,
wherein the correction amount calculator calculates an estimated outside air temperature based on a transition of the detected temperature from the temperature sensor, and the correction amount calculator determines the correction amount based on the estimated outside air temperature.

7. The correction amount setting apparatus according to claim 6,
wherein, at the first timing, the correction amount calculator calculates the estimated outside air temperature based on the transition of the detected temperature from the temperature sensor, and the correction amount calculator determines the correction amount based on the estimated outside air temperature.

8. The correction amount setting apparatus according to claim 1,
wherein a second timing at which the correction amount calculator determines the correction amount and a third timing at which the correction amount setter sets the correction amount for the at least one sound wave sensor are approximately the same timing.

9. The correction amount setting apparatus according to claim 1,
wherein the correction amount setter integrates a traveling duration during which, after the vehicle starts to travel, vehicle travels at a speed higher than the first reference speed, and sets, as the first timing, a timing at which the vehicle is decelerated to the first reference speed after an integrated value of the traveling duration becomes longer than a threshold duration.

10. The correction amount setting apparatus according to claim 1,
wherein the temperature sensor includes
a first temperature sensor that is built in the at least one sound wave sensor and detects an outside air temperature around the at least one sound wave sensor, and
a second temperature sensor that is provided at a position different from a position of the at least one sound wave sensor to be in contact with outside air and detects an outside air temperature around the vehicle,
wherein the correction amount calculator determines the correction amount based on the detected temperature from the first temperature sensor and the detected temperature from the second temperature sensor, and
wherein the correction amount calculator determines whether a difference between the detected temperature from the first temperature sensor and the detected temperature from the second temperature sensor is greater than or equal to a first threshold temperature, and when the difference is greater than or equal to the first threshold temperature, the correction amount calculator determines the correction amount such that a temperature compensation amount for a reference value of the sensitivity or the threshold is suppressed more than in a case where the difference is less than the first threshold temperature.

11. The correction amount setting apparatus according to claim 10,
wherein the correction amount setter determines whether the difference between the detected temperature from the first temperature sensor and the detected temperature from the second temperature sensor is greater than or equal to a second threshold temperature, the second threshold temperature being higher than the first threshold temperature, and when the difference is greater than or equal to the second threshold temperature, the correction amount setter does not set the correction amount for the at least one sound wave sensor.

12. The correction amount setting apparatus according to claim 1,
wherein the at least one sound wave sensor comprises a plurality of sound wave sensors in each of which the temperature sensor is built,
wherein the plurality of sound wave sensors are mounted on the vehicle,
wherein the correction amount calculator acquires information regarding detected temperatures from the temperature sensors built in the plurality of sound wave sensors, respectively, and, under a predetermined condition, determines the correction amount by selectively using the detected temperatures from the temperature sensors on a front side with respect to a traveling direction of the vehicle from among the temperature sensors built in the plurality of sound wave sensors, and
wherein the correction amount setter sets the correction amount that is common for the plurality of sound wave sensors.

13. The correction amount setting apparatus according to claim 12,
wherein the predetermined condition is a case where the vehicle is traveling.

14. The correction amount setting apparatus according to claim 13,
wherein the predetermined condition is a case where a difference between the detected temperature from the temperature sensor provided on the front side with respect to the traveling direction of the vehicle among the temperature sensors built in the plurality of sound wave sensors, respectively, and the detected temperature from the temperature sensor provided on a rear side with respect to the traveling direction of the vehicle among the temperature sensors built in the plurality of sound wave sensors, respectively, is greater than or equal to a threshold temperature.

15. The correction amount setting apparatus according to claim 13,
wherein the predetermined condition is a case where a slope of a traveling route on which the vehicle is traveling is greater than to a threshold angle, a case where an elevation of the traveling route on which the vehicle is traveling changes by a threshold elevation or more within a predetermined distance or a predetermined duration, or a case where the vehicle is near a refrigeration facility.

16. The correction amount setting apparatus according to claim 1,
wherein the at least one sound wave sensor comprises a plurality of sound wave sensors in each of which the temperature sensor is built in,
wherein the plurality of sound wave sensors are mounted on the vehicle,
wherein the correction amount calculator acquires information regarding detected temperatures from the temperature sensors built in the plurality of sound wave sensors, respectively, and determines the correction amount by selectively using a second lowest detected temperature of the detected temperatures from the temperature sensors built in the plurality of sound wave sensors, respectively, and
wherein the correction amount setter sets the correction amount that is common for the plurality of sound wave sensors.

17. The correction amount setting apparatus according to claim 16,
wherein the correction amount calculator determines the correction amount by selectively using the detected temperatures from the temperature sensors built in the sound wave sensors, respectively, provided on a front side with respect to a traveling direction of the vehicle from among all the sound wave sensors mounted on the vehicle.

18. An ultrasonic object detecting apparatus comprising:
the correction amount setting apparatus according to claim 1.

19. A correction amount setting method for setting a correction amount for a sound wave sensor that is mounted on a vehicle and that detects an obstacle by transmitting and receiving a sound wave, the correction amount being a correction amount of a sensitivity to a reflection wave or a threshold for determining whether an obstacle is present, the correction amount setting method comprising:
first processing in which information regarding a detected temperature is acquired from a temperature sensor that detects an outside air temperature around the vehicle, and the correction amount is determined based on the detected temperature detected by the temperature sensor; and
second processing in which the correction amount is set for the sound wave sensor,
wherein, in the second processing, the correction amount is determined and set for the sound wave sensor at a timing, the timing being a time at which, from start of traveling of the vehicle, the vehicle, after having been accelerated to a speed higher than a first reference speed, is decelerated to the first reference speed.

20. A non-transitory computer-readable recording medium having a correction amount setting program stored therein, the correction amount setting program being for setting a correction amount for a sound wave sensor that is mounted on a vehicle and that detects an obstacle by transmitting and receiving a sound wave, the correction amount being a correction amount of a sensitivity to a reflection wave or a threshold for determining whether an obstacle is present, the correction amount setting program comprising:
first processing in which information regarding a detected temperature is acquired from a temperature sensor that detects an outside air temperature around the vehicle and the correction amount is determined based on the detected temperature detected by the temperature sensor; and
second processing in which the correction amount is set for the sound wave sensor,
wherein, in the second processing, the correction amount is determined and set for the sound wave sensor at a timing, the timing being a time at which, from start of traveling of the vehicle, the vehicle, after been accelerated to a speed higher than a first reference speed, is decelerated to the first reference speed.
